(19) United States
(12) Patent Application Publication
(10) Pub. No.: US 2009/0174846 A1
(43) Pub. Date: Jul. 9, 2009

(54) POLARIZING PLATE AND LIQUID CRYSTAL DISPLAY DEVICE EQUIPPED WITH THE SAME

(75) Inventor: Yoji Ito, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/281,577

(22) PCT Filed: Mar. 2, 2007
(86) PCT No.: PCT/JP2007/054616

§ 371 Date: Sep. 3, 2008

(30) Foreign Application Priority Data
Mar. 3, 2006 (JP) 2006-058696
Mar. 1, 2007 (JP) 2007-051316

(51) Int. Cl. G02F 1/13363; G02B 5/30; G02B 1/08

(52) U.S. Cl. 349/96; 359/500

(57) ABSTRACT

Disclosed is a polarizing plate comprising a protective film and a liquid crystal display device that utilizes the polarizing plate, wherein the protective film has a moisture permeability of 1 g/m²/24 h to 100 g/m²/24 h.

### TECHNICAL FIELD

The present invention relates to polarizing plates and liquid crystal display devices equipped with the polarizing plates.

### BACKGROUND ART

Polarizing plates are typically produced by laminating a cellulose triacetate-based film as a protective film onto both sides of a polarizing film which having been formed through orienting polyvinyl alcohol (PVA) and absorbing a dichroic dye or iodine thereto.

The cellulose triacetate may provide excellent features in terms of toughness, flame resistance and optical isotropy (lower retardation values), therefore has been widely utilized for the protective film of polarizing plates. The liquid crystal display devices are typically constructed from a polarizing plate and a liquid crystal cell.

TFT liquid crystal display devices of TN-mode, which being currently dominant in liquid crystal display devices, achieve higher quality display by virtue of optical compensation film, i.e. phase-difference or retardation film, interposed between a polarizing plate and a liquid crystal cell (Patent Literature 1). However, this configuration suffers from higher thickness of liquid crystal display devices themselves.

On the other hand, Patent Literature 2 describes that an elliptic polarizing plate having an optical compensation film on one side of polarizing film as well as a protective film on the other side can bring about higher front contrast without thickening liquid crystal display devices. However, it has been found that the optical compensation film lacks durability since its thermal distortion tends to cause a phase difference.

For the countermeasure of the phase difference due to such distortion, Patent Literatures 3 and 4 describe that a direct application of an optical compensation film, provided by coating an optically anisotropic layer made of a discotic compound on a transparent support, into a protective film for polarizing plates may solve the insufficient durability without thickening the liquid crystal display devices.

However, liquid crystal devices having a polarizing plate, which integrating an optical compensation film and a polarizing film, often suffer with time from polarization-degree drop of the polarizing film and brightness drop of the liquid crystal devices even though view angle being widened.

Patent Literature 5 discloses that controlling moisture permeability of protective film of polarizing plates may suppress the influence of moisture, which being a cause of polarization-degree drop, while maintaining productivity, thus the problem may be solved.

Patent Literature 6 discloses a moisture-proof layer that contains plate-like fine particles of smectite etc. dispersed in binders such as PVA and PVDC.

In recent years, liquid crystal devices have been widely applied for liquid crystal televisions and been increasing their shear rate, along with proposing wide view-angle liquid crystal systems such as of IPS, OCB and VA. These systems have been improving their display quality year by year, whereas such insufficient durability as described above has been exposed in public (Patent Literatures 7 to 20).

The present inventors have been vigorously investigated and found that the insufficient durability comes from moisture penetration into polarizing film of polarizing plates for liquid crystal display devices. The moisture may be residual one at producing the polarizing plate in some cases, or atmospheric moisture where the liquid crystal display device being present in some cases. On the other hand, protective film with no moisture permeability is unavailable from the stand point of production processes of polarizing plates.

Accordingly, various technologies have been proposed to solve the problem in terms of the durability, however, such a polarizing plate has not yet been provided that may exhibit sufficient durability to maintain polarization degree of polarizing film and also such a liquid crystal display device has not yet been provided that may be free from problems and of high quality, even with conventional thicknesses.

Patent Literature 1: Japanese Patent Application Laid-Open (JP-A) No.

Patent Literature 2: JP-A No. 01-68940

Patent Literature 3: JP-A No. 07-191217

Patent Literature 4: European Patent No. 0911656 A2

Patent Literature 5: JP-A No. 2002-14230

Patent Literature 6: JP-A No. 2003-294943

Patent Literature 7: JP A No. 09-211444

Patent Literature 8: JP-A No. 11-316378

Patent Literature 9: JP-A No. 02-176625

Patent Literature 10: JP-A No. 11-95208

Patent Literature 11: JP-A No. 2003-15134

Patent Literature 12: JP-A No. 11-95208

Patent Literature 13: JP-A No. 2002-221622

Patent Literature 14: JP-A No. 09-80424

Patent Literature 15: JP-A No. 10-54982

Patent Literature 16: JP-A No. 11-202323

Patent Literature 17: JP-A No. 09-292522

Patent Literature 18: JP-A No. 11-133408

Patent Literature 19: JP-A No. 11-305217

Patent Literature 20: JP-A No. 10-307291

### DISCLOSURE OF THE INVENTION

The present invention aims to solve the problems described above and to attain the objects described below. That is, it is an object of the present invention to provide a polarizing plate that exhibits superior durability for maintaining a polarization degree of polarizing film and excellent productivity thereof. It is another object of the present invention to provide a liquid crystal display device that exhibits superior durability and higher display quality with substantially no problem under conventional thicknesses.

The objects may be attained by the present invention; in a first aspect, the present invention provides a polarizing plate that comprises at least one protective film, wherein the protective film has a moisture permeability of 1 g/m²/24 h to 100 g/m²/24 h.

Preferably, the protective film is formed of at least two layers, and one of the layers is a moisture permeability-control layer capable of controlling the moisture permeability of the protective layer.

Preferably, the moisture permeability-control layer comprises a silicon-containing compound.

Preferably, two protective films are disposed at both sides of a polarizer, and at least one of the protective films is formed from cellulose acylate.

Preferably, in-plane retardation value (Re) of the protective film is 0 nm to 100 nm for light of wavelength 550 nm, and thickness-direction retardation (Rth) of the protective film is 0 nm to 300 nm for light of wavelength 550 nm.

Preferably, the protective film has an A1 value of 0.10 to 0.95 and an A2 value of 1.01 to 1.50, calculated respectively by Equations (1) and (2) below,

A1 value=Re₍₄₅₀₎/Re₍₅₅₀₎: Equation (1)

A2 value=Re₍₆₅₀₎/Re₍₅₅₀₎: Equation (2)

in Equations (1) and (2), Re₍₄₅₀₎ represents an in-plane retardation value of the protective film for light of wavelength 450 nm, Re₍₅₅₀₎ represents an in-plane retardation value of the protective film for light of wavelength 550 nm, and Re₍₆₅₀₎ represents an in-plane retardation value of the protective film for light of wavelength 650 nm.

Preferably, the protective film has a B1 value of 0.40 to 0.95 and a B2 value of 1.05 to 1.93, calculated respectively by Equations (3) and (4) below, and Rth₍₅₅₀₎ is 0 nm to 300 nm,

B1 value={Re₍₄₅₀₎/Rth₍₄₅₀₎}/{Re₍₅₅₀₎/Rth₍₅₅₀₎}: Equation (3)

B2 value={Re₍₆₅₀₎/Rth₍₆₅₀₎}/{Re₍₅₅₀₎/Rth₍₅₅₀₎}: Equation (4)

in Equations (3) and (4), Re_{(λ)} represents an in-plane retardation value of the protective film for light of wavelength λ nm, Rth_{(λ)} represents a thickness-direction retardation value of the protective film for light of wavelength λ nm.

In another aspect, the present invention provides a liquid crystal display device that comprises a polarizing plate described above and a liquid crystal cell.

Preferably, the liquid crystal cell is of VA, OCB, or IPS mode.

### BRIEF DESCRIPTION OF DRAWINGS

FIG. 1 is a view that shows a construction of a liquid crystal display device according to the present invention.

FIG. 2 is a view that exemplarily shows a calculation between angles of phase-delay axis, one of the two specific polarization axes, and Re/Rth, in a case that light enters from oblique directions into the optical compensation film in the present invention.

FIG. 3A is a view that shows a change of polarization condition in terms of G light entered from left 60° into the liquid crystal display device shown in FIG. 1.

FIG. 3B is a view that shows a change of polarization condition in terms of G light entered from right 60°.

FIG. 4A is a view that shows the changes of polarization condition of lights R, G and B entered from left 60°.

FIG. 4B is a view that shows the changes of polarization condition of lights R, G and B entered from right 60°.

FIG. 5A is a view that shows the changes of polarization condition of lights R, G, B entered from left 60°.

FIG. 5B is a view that shows the changes of polarization condition of lights R, G, B entered from right 60°.

FIG. 6 is a graph of wavelength dispersion for various supports and optical compensation films.

### BEST MODE FOR CARRYING OUT THE INVENTION

The polarizing plate according to the present invention and the liquid crystal display device equipped with the plate will be explained in detail below.

In the explanation below, the terms of “45°”, “parallel” and “perpendicular” each mean its strict angle with an allowable range of ±5°. The difference from the strict angle is preferably less than ±4°, more preferably less than ±30. The mark “+” in terms of angles indicates clockwise direction, and the mark “−” indicates anticlockwise direction. The term “phase-delay axis” means the direction at which the refractive index is the highest.

The “visible light region” corresponds to 380 to 780 nm. The refractive indices are those measured at wavelength 550 nm in visual range unless indicated otherwise.

The term “polarizing plate” refers, in the explanation below, to longer plates as produced and also shorter plates cut into the size for liquid crystal display devices; the “cut” encompasses “punching out”, “cutout”, or the like.

The terms “polarizing film” and “polarizing plate”, in the explanation below, are differently expressed in general, in which the “polarizing plate” typically means a laminate having a transparent protective film on at least one side of the “polarizing film” for its protection.

In the explanation below, in cases where a molecule has a rotational symmetric axis, the term “molecular symmetric axis” indicates exactly the rotational symmetric axis; however, the molecular symmetry is not necessarily required to be rotationally symmetric.

In general, disc-shaped liquid crystal compounds have a molecular symmetric axis that coincides with an axis penetrating through the disc center and extending perpendicular to the disc surface; rod-like liquid crystal compounds have a molecular symmetric axis that coincides with the molecular long axis.

In this specification, Re(λ) and Rth(λ) are an in-plane retardation and a thick retardation at wavelength λ respectively. The Re(λ) can be determined by irradiating a light of wavelength λ nm along a normal line of a film using KOBRA 21ADH (by Oji Scientific Instrument).

Rth(λ) can be determined by measuring eleven Re(λ) values through irradiating a light of wavelength (λ nm) along directions inclined from −50° to +50° with 10° step from the normal line of the film considering the in-plane retard phase axis (determined using KOBRA 21ADH) as the inclined axis (rotation axis), and calculating from the resultant retardation values, the estimated average refractive index, and input film-thickness value by use of KOBRA 21ADH.

The average refractive indices can be assumably picked up from Polymer Handbook (John Wikey & Sons, Inc) and nominal values in catalogues of optical films. When the average refractive indices are unknown, they can be measured using Abbe refractometer.

Representative values of average refractive indices of prevailing optical films are as follows: cellulose acylate (1.48), cycloolefin polymer (1.52), polycarbonate (1.59), polymethylmethacrylate (1.49) and polystyrene (1.59).

These estimated values of average refractive indices and film thickness are input then nx, ny and nz can be calculated using the KOBRA 21ADH. The resulting nx, ny and nz can subsequently bring about Nz=(nx−nz)/(nx−ny).

### Polarizing Plate

It is preferred that the polarizing plate according to the present invention is comprised of a polarizing film and a pair of protective films that sandwich the polarizing film, from the viewpoint of polarizing ability and transmissivity. Such a polarizing plate is available, for example, by way of dying a polarizing film of polyvinyl alcohol (PVA) film by use of iodine and stretching the film, then laminating the protective film to the both sides.

The polarizing plate according to the present invention contains a moisture permeability-control layer, for controlling the moisture permeability through the protective film, in addition to the protective film having a laminate construction with two or more layers.

It is preferred in the embodiments according to the present invention that a pair of polarizing plates with the construction described above are disposed to sandwich a liquid crystal. The present invention is not limited to the construction, and also applicable to coated polarizing plates such as of Optiva, in which the protective film corresponds to a coated support.

### Protective Film

The inventive protective film (hereinafter sometimes referred to as “optical compensation film”) may be properly selected depending on the application as long as being a transparent film having a moisture permeability of 1 to 100 g/m²/24 h, more preferably 10 to 80 g/m²/24 h.

When the protective film has excessively lower moisture permeabilities, the moisture in adhesive tends to remain at between the optical compensation film and the polarizing film of the polarizing plate, then moisture remaining in the polarizing plate tends to penetrate into the polarizing film, resulting in degradation of polarizing ability of the polarizing film.

On the other hand, when the protective film has excessively higher moisture permeabilities, the environmental moisture at the polarizing plate tends to penetrate into the polarizing plate then into the polarizing film, resulting also in degradation of polarizing ability of the polarizing film. The inventive protective film may be stretched polymer films or combinations of coated polymer layers and polymer films.

Furthermore, in the process for producing a polarization film, there exists a step to reduce moisture by passing through a protective film, therefore, it is preferred that the inventive protective film is applied to only one side of the polarization film.

### Control of Moisture Permeability

The moisture permeability may be controlled by thickness of polymer film or liquid crystal compounds, free volume, and additives (hydrophilic or hydrophobic) to the polymer film; the details are described in JP-A No. 2002-14230.

As such, the inventive protective film has a moisture permeability-control layer for maintaining the moisture permeability within the range described above. Specifically, a layer having a considerably low moisture permeability is provided on the surface of the protective film thereby to maintain the moisture permeability within the range.

The main ingredient of the layer, having considerably low moisture permeabilities, is preferably vinylidene chloride, vinyl acetal, norbornene, smectite fine particles, diamond carbon; or silicon-containing compounds such as silicon nitride and silicon carbide.

Preferably, the main ingredient is silicon-containing compounds in view of coating of the protective film and handling at kneading; more preferably, layers containing the compounds as described in JP-A No. 2005-325174 are employed.

The method for measuring moisture permeability may be on the base of the method described in “Polymer Physicality II, Polymer Experimental Course No. 4, Kyoritsu Shuppan Co., pp. 285-294, Measurement of Vapor Penetration Amount (weight, thermometer, vapor pressure and absorption methods)”.

The protective film for the inventive polarizing plate may also perform as an optical anisotropic layer (optical compensation film) as described later; it is preferred in particular that the protective film at the side of liquid crystal cell may have the performance.

The inventive protective film preferably has an optical anisotropy, more preferably, the protective film at the side of liquid crystal cell has an optical anisotropy.

In such cases, the protective film has an A1 value, obtained from Equation (1) below, preferably in a rage of 0.10 to 0.95, more preferably 0.3 to 0.8, still more preferably 0.5 to 0.75.

In addition, the inventive protective film has an A2 value, obtained from Equation (2) below, preferably in a rage of 1.01 to 1.50, more preferably 1.10 to 1.45, still more preferably 1.20 to 1.40.

In the Equations (1) and (2) below, Re₍₄₅₀₎ represents a retardation value of a film for light of wavelength 450 nm, Re₍₅₅₀₎ represents a retardation value of a film for light of wavelength 550 nm, Re₍₆₅₀₎ represents a retardation value of a film for light of wavelength 650 nm.

A1 value=Re₍₄₅₀₎/Re₍₅₅₀₎: Equation (1)

A2 value=Re₍₆₅₀₎/Re₍₅₅₀₎: Equation (2)

It is preferred that the absolute value of Re is adjusted to an appropriate range depending on the embodiments of liquid crystal layers. In cases of OCB and VA modes, the value is 20 to 110 nm for example, preferably 20 to 70 nm, more preferably 35 to 70 nm.

A favorable process to control the Re of the inventive protective layer is such that a transparent polymer film is stretched at 25° C. to 100° C. of the glass transition temperature Tg of the polymer.

The transmissivity of the protective film is preferably no less than 85%, more preferably no less than 90%.

The inventive stretching process may bring about optical compensation film with higher transmissivities than those of other processes even starting from identical materials. The present inventors believe that stretching at remarkably higher temperatures may lead to evaporation of impurities in polymer materials, which bringing about drop of scattering factors in optical compensation film.

The mechanism to control Re at each wavelength into a desirable value under high-temperature stretching will be explained with respect to cellulose acylate which being one of most preferable embodiments.

The cellulose acylate is typically comprised of a main chain consisting of glucopyranose ring and a side chain of acyl group; upon stretching the film of cellulose acylate, Re generates through orienting the main chain in the stretching direction.

The present inventors have investigated vigorously and found that stretching at remarkably higher temperatures like 175° C. to 210° C. (Tg of the cellulose acylate: 140° C.) may bring about Re drop at 450 nm and Re rise at 650 nm.

In addition, there appears an X-ray diffraction peak, possibly derived from crystallization, in the cellulose acylate film stretched at higher temperatures, which suggesting that the orientation condition of the main and side chains has changed through the crystallization and thus Re has changed its wave dependency.

That is, the crystallization is an important factor in order to achieve the inventive optical compensation film, and the orientation degree P of the main chain, defined by the Equation (I) on the basis of X-ray diffraction, is preferably 0.04 to 0.30, more preferably 0.06 to 0.25.

In the Equation (I) below, β is an angle between an entrance face of incident X ray and a certain direction within a film face, I is a diffracted intensity at 2θ=8° in the X-ray diffraction chart measured at the angle β.

P=(3 cos 2β−1)/2: Equation (I)

in which, cos 2β=∫(0, π)cos² βI(β)sin βdβ/∫(0, π)I(β)sin βdβ

On the other hand, it is important that Rth is controlled in order to improve color shift of liquid crystal display devices. It is preferred that Re₍₄₅₀ₙₘ₎/Rth₍₄₅₀ₙₘ₎, which being a ratio of Re/Rth at wavelength 450 nm in visual light region, is 0.10 to 0.95 time of the Re₍₅₅₀ₙₘ₎/Rth₍₅₅₀ₙₘ₎ at wavelength 550 nm, more preferably 0.4 to 0.8 time, still more preferably 0.5 to 0.7 time.

In addition, it is preferred that Re₍₆₅₀ₙₘ₎/Rth₍₆₅₀ₙₘ₎ at wavelength 650 nm is 1.01 to 1.9 times of the Re₍₅₅₀ₙₘ₎/Rth₍₅₅₀ₙₘ₎, more preferably 1.1 to 1.7 times, still more preferably 1.3 to 1.6 times.

Each Re/Rth at R, G and B is preferably in a range of 0.1 to 0.8.

The inventive protective film has a preferable range of retardation value (Rth) in entire thickness direction depending on liquid crystal layers due to the function to cancel the retardation of liquid crystal layers in the thickness direction at black display.

When the protective film is employed for optical compensation of liquid crystal cells of OCB mode (for example, product Δn·d=0.2 to 1.5 μm, Δn: refractive index anisotropy, d: thickness (μm)), the retardation value (Rth) is preferably 0 to 300 nm, more preferably 100 to 300 nm, still more preferably 130 to 200 nm.

The Rth may be appropriately controlled by way of coating liquid crystal layers, incorporating various additives, or the like.

The material for the protective films to satisfy the requirements described above may be films of silicon-containing resins or cellulose acylate.

### Silicon-Containing Resin

The silicon-containing resin, for controlling the moisture permeability in the present invention, is preferably organic-inorganic complex materials in which elemental materials are combined in a domain size of nano meter level or molecular level.

Such a material can be expected to provide novel functions over the elemental materials, i.e. be unpredictable from their additivity, in addition to the properties or advantages of the respective elemental materials (e.g. Journal of Chemical Society of Japan, No. 9, 571, 1998).

Furthermore, curable compositions, containing a specific silicon-containing polymer, may be favorable as an organic-inorganic complex material of chemical bond type (JP-A No. 2002-356617). The silicon-containing resin described in JP-A is more preferable one.

The raw cotton for the cellulose acylate utilized for the inventive protective film may be properly selected depending on the application from conventional raw materials (e.g. Open Technology 2001-1745 of Japanese Institute of Invention and Innovation).

The synthesis of the cellulose acylate may be carried out by conventional processes (e.g. Migita et al., Mokuzai Kagaku, pp. 180-190, Kyoritsu Shuppan Co., 1968). Preferably, the average polymerization degree of the cellulose acylate is 200 to 700, more preferably 250 to 500, particularly preferably 250 to 350.

Preferably, the cellulose ester used in the present invention has a narrower molecular weight distribution in terms of Mw/Mn (Mw: mass average molecular weight, Mn: number average molecular weight) measured by gel permeation chromatography. Specific values of the Mw/Mn are preferably 1.5 to 5.0, more preferably 2.0 to 4.5, particularly preferably 3.0 to 4.0.

The acyl group of the cellulose acylate is preferably an acetyl group or propionyl group, particularly preferably an acetyl group. The substitution degree of the total acyl groups is preferably 2.7 to 3.0, more preferably 2.8 to 2.95. In this specification, the substitution degree of the acyl group is the value determined in accordance with American Society for Testing and Materials (ASTM) D817.

The acyl group is most preferably an acetyl group. When a cellulose acetate having an acetyl group as the acyl group is used, the acetification degree is preferably 57.0% to 62.5%, more preferably 58.0% to 62.0%. The acetification degree of this range may prevent excessive Re rise under a transportation tension at flow casting, the in-plane Re fluctuation may be reduced, and also Re fluctuation due to various temperatures and humidities may be reduced.

It is preferred in particular that Equations (II) and (III) shown below are satisfied from the viewpoint of lower Re fluctuation under various temperatures and humidities, in which hydroxide group of glucose units of cellulose in the cellulose acylate film is prepared through substituting an acyl group with a carbon atom number of two or more, DS2 indicates the substitution degree of second site of the glucose unit, DS3 indicates the substitution degree of third site of the glucose unit, and DS6 indicates the substitution degree of sixth site of the glucose unit.

2.0≦DS2+DS3+DS6≦3.0: Equation (II)

DS6/(DS2+DS3+DS6)≧3.15: Equation (III)

### Stretching

The inventive cellulose acylate film exhibits their functions through stretching. It is preferred that the cellulose acylate film is stretched toward the width direction for applying into polarizing plates, as described in JP-A Nos. 62-115035, 04-152125, 04-284211, 04-298310 and 11-48271.

The stretching of the cellulose acylate film may be carried out at 25° C. to 100° C. as described above. The stretching of films may be carried out mono-axially or biaxially.

The inventive cellulose acylate film may be stretched in their drying process, which is effectively carried out when residual solvent exists in particular. For example, the cellulose acylate film can be stretched by controlling the velocity of conveyer rollers such that the take-up speed of the cellulose acylate film is higher than the peeling velocity thereof.

The cellulose acylate film can also be stretched by conveying the film while supporting their edges with tenters and gradually widening the distance of tenters. The cellulose acylate film can be stretched by use of a stretching machine after drying the cellulose acylate film, preferably the stretching is carried out mono-axially using a Long stretching machine. The draw ratio of the cellulose acylate film, i.e. the ratio of stretched length to original length, is preferably 0.5% to 300%, more preferably 1% to 200%, particularly preferably 1% to 100%.

The cellulose acylate film is preferably produced through sequentially or continuously carrying out a film-forming step of solvent-cast process and a stretching step of formed film; preferably, the draw ratio is 1.2 to 1.8. The stretching may be carried out through one step or multi-steps. In cases of multi-steps, the product of respective draw ratios is to be controlled into this range.

Preferably, the stretching velocity is 5 to 1000%/min, more preferably 10 to 500%/min. Preferably, the stretching temperature is 30° C. to 160° C., more preferably 70° C. to 150° C., particularly preferably 85° C. to 150° C.

The stretching is preferably carried out by use of a heat roll and/or an irradiation-heat source or warm gas flow. A constant-temperature bath may also be provided in order to enhance the temperature uniformity. In cases of mono-axial stretching through roll-stretching, the ratio L/W (L: distance between rolls, W: film width of phase-different plate) is preferably 2.0 to 5.0.

Preferably, a preheating step is provided before the stretching. Heat treatment may be carried out after the stretching. Preferably, the temperature of the heat treatment is from 20° C. lower to 10° C. higher than the glass transition temperature Tg of the cellulose acylate film; preferably, the period of the heat processing is 1 second to 3 minutes.

The heating process may be of zone heating or of partial heating by use of IR heaters. The both edges of films may be slit away during or after the processes. The slit debris is preferably collected and reused as the raw material.

Concerning the tenters used for supporting edges of films, as described in JP-A No. 11-077718, when webs are dried while supporting the edges by the tenters, such factors as blowing process of drying gas, blowing angle, gas-velocity distribution, gas speed, gas amount, temperature difference, gas-amount difference, gas-amount ratio between upper and lower blowing, and use of drying gas with higher specific heat may be appropriately controlled, thereby deteriorated quality in terms of planarity etc. may be prevented due to increasing the speed of solution flow-casting processes or enlarging the web width; these descriptions may be incorporated herein by reference.

JP-A No. 11-077822 describes a technology in order to prevent non-uniformity, in which thermoplastic films are stretched, followed by heat-treating the films with a thermal gradient in width direction of films in a heat relaxation step; these descriptions may be incorporated herein by reference.

JP-A No. 04-204503 describes a technology in order to prevent non-uniformity, in which films are stretched in a solvent content of 2% to 10% based on solid content; these descriptions may be incorporated herein by reference.

JP-A No. 2002-248680 describes a technology in order to inhibit curling of films by defining an engaging width of clips, in which films are stretched at a tenter-clip-engaging width D≦(33/(log(draw ratio)×log(volatile)) thereby to inhibit the curling and to make easy the film transportation after the stretching step; these descriptions may be incorporated herein by reference.

JP-A No. 2002-337224 describes a technology in order to combine high-speed transportation of soft films and stretching, in which tenter transportation is carried out while switching pins for the first half to clips for the last half; these descriptions may be incorporated herein by reference.

JP-A No. 2002-187960 describes a technology concerning optical twin axis in order to conveniently improve view-angle properties and to improve view angle, in which a cellulose-ester dope-liquid is flow-cast into a support, then a web or film separated from the support is stretched 1.0 to 4.0 times in at least one direction when solvents remain within the web in a range of no more than 100% by mass, particularly 10 to 100% by mass. It is also described as a preferable embodiment that stretching in at least one direction is carried out by 1.0 to 4.0 times when solvents remain within the web in a range of no more than 100% by mass, particularly 10 to 100% by mass.

In addition, the other stretching processes may be exemplified as follows: plural rolls with different circumferential velocities are provided, and the stretching is carried out longitudinally by use of different circumferential velocities; both edges of webs are fixed by clips or pins, and the stretching is carried out longitudinally while the distance of the clips or pins is expanded in a progressing direction, or the stretching is carried out traversely while expanding traversely, or the stretching is carried out longitudinally and traversely while expanding longitudinally and traversely; or combination thereof.

In cases of so-called tenter processes, it is described that driving of the clip portions under a linear-drive process may lead to smooth stretching, thus the possibility of breakages may be favorably lowered; these descriptions may be incorporated herein by reference.

In addition, JP-A No. 2003-014933 describes a technology in order to produce phase-difference films with less breed out of additives, less inter-layer peeling, superior lubrication property and excellent transparency, in which dope A containing a resin, additive and organic solvent and dope B containing no or less amount of additives, a resin and an organic solvent are prepared; the dope A and the dope B are co-flow cast on a support in a manner that the dope A forms a core layer and the dope B forms a surface layer; a web is peeled off from the support after the solvent being evaporated; the web is stretched 1.1 to 1.3 times in at least one direction when the solvent remains within the resin film in a range of 3 to 50% by mass at the stretching.

The literature also describes, as preferable embodiments, that the web is peeled off from the support and stretched 1.1 to 1.3 times in at least one direction at a stretching temperature of 140° C. to 200° C.; the dope A containing a resin and organic solvent and the dope B containing a resin, fine particles and organic solvent are prepared; the dope A and the dope B are co-flow cast on a support in a manner that the dope A forms a core layer and the dope B forms a surface layer; a web is peeled off from the support after the solvent being evaporated; the web is stretched 1.1 to 1.3 times in at least one direction when the solvent remains within the resin film in a range of 3 to 50% by mass at the stretching, and also the stretching is carried out 1.1 to 1.3 times in at least one direction at a stretching temperature of 140° C. to 200° C.; the dope A containing a resin, organic solvent and additive, the dope B containing no or less amount of additives, a resin and organic solvent, and the dope C containing a resin, fine particles and organic solvent are prepared; the dope A, the dope B and the dope C are co-flow cast on a support in a manner that the dope A forms a core layer, the dope B forms a surface layer and the dope C forms a opposite surface layer; a web is peeled off from the support after the solvent being evaporated; the web is stretched 1.1 to 1.3 times in at least one direction when the solvent remains within the resin film in a range of 3 to 50% by mass at the stretching, and also the stretching is carried out 1.1 to 1.3 times in at least one direction at a stretching temperature of 140° C. to 200° C.; the content of additives in the dope A is 1 to 30% by mass based on the resin, the content of additives in the dope B is 0 to 5% by mass based on the resin; the additive is a plasticizer, UV ray absorber, or retardation control agent; the organic solvents in the dope A and the dope B contains methylene chloride or methylacetate in a content of no less than 50% by mass based on entire solvent; these descriptions may be incorporated herein by reference.

JP-A No. 2003-014933 describes a stretching process that appropriately utilizes a traverse-stretching machine so-called a tenter, in which both edges of webs are fixed by clips or pins, the webs are traversely stretched while traversely stretching the distance of clips or pins. It is also disclosed that stretching or shrinking in longitudinal direction is carried out by way of stretching or shrinking the distance of clips or pins in the conveying direction (longitudinal direction).

It is also disclosed that the stretching may be carried out smoothly by way of driving clip portions using a linear-drive system, thus the possibility of breakages may be favorably lowered; plural rolls with different circumferential velocities are provided, and the stretching is carried out longitudinally by use of the different circumferential velocities.

It is also described that these processes may be combined, and the stretching process may be divided into two or more steps, e.g. longitudinal stretching/traverse stretching/longitudinal stretching, or longitudinal stretching/longitudinal stretching; these descriptions may be incorporated herein by reference.

JP-A No. 2003-004374 describes a technology in order to prevent foaming of webs at tenter-drying, to improve releasability and to prevent dusts, in which the width of dryers is shorter than the width of the webs so that hot gas does not blow the both edges of webs; these descriptions may be incorporated herein by reference.

JP-A No. 2003-019757 describes a technology in order to prevent foaming of webs at tenter-drying, to improve releasability and to prevent dusts, in which wind-shielding plates are provided inside both edges of webs so as to shield the drying gas at supporting portions of tenters; these descriptions may be incorporated herein by reference.

JP-A No. 2003-053749 describes a technology in order to carry out stably the conveyance and drying, in which X (X: dried thickness (μm) of both edges of films supported by pin tenters) and T (T: dried average thickness (μm) of product portions of films) satisfy the following relations; these descriptions may be incorporated herein by reference.

(i) when T≦60, 40<x≦200,

(ii) when 60<T≦120, 40+(T−60)×0.2≦x≦300, or

(iii) when T<120, 52+(T−120)×0.2≦x≦400

JP-A No. 02-182654 describes a technology in order to prevent corrugation from multi-step tenters, in which a heating room and a cooling room are provided in dryers of multi-step tenters, right and left clip chains are separately cooled; these descriptions may be incorporated herein by reference.

JP-A No. 09-077315 describes a technology in order to prevent breakage, corrugation and inferior transportation, in which pin density of pin tenters is larger at inner side and smaller at outer side; these descriptions may be incorporated herein by reference.

JP-A No. 09-085846 describes a technology in order to prevent foaming of webs themselves and web adhesion to sustainers in tenters, in which sustaining pins for both web edges are cooled under web-foaming temperature by use of a blowing cooler, and also the pins immediately before piercing webs are cooled to no more than +15° C. of dope-gelling temperature by use of a duct-type cooler; these descriptions may be incorporated herein by reference.

JP-A No. 2003-103542 describes a technology that relates to a process for forming films from solutions in order to prevent dropout of pin tenters and to address foreign matter, in which inserting bodies of pin tenters are cooled so as to suppress the surface temperature of webs contacting with the inserting bodies below the gelling temperature of webs; these descriptions may be incorporated herein by reference.

JP-A No. 11-077718 describes a technology in order to prevent quality degradation of planarity, when speed of solution flow-casting processes is raised or web width is enlarged by use of tenters, in which wind velocity is controlled to 0.5 to 20 m/sec, temperature distribution in traverse direction is controlled to no more than 10%, wind ratio at upper and lower webs is controlled to 0.2 to 1, and drying gas ratio is controlled to 30 to 250 J/kmol. The favorable drying conditions are also disclosed within tenters corresponding to residual solvent amount.

Specifically, webs are dried in such manner that while after a web is peeled off a support and before the residual solvent content comes to 4% by mass, the blowing angle from a blowing suction is adjusted 300 to 1500 against the film plane, and the web is dried under drying gas in a condition that the difference of the upper and the lower limits of wind velocity is adjusted to no more than 20% of the upper limit, wherein the upper limit is defined from velocity distribution on film surface at extended position on blowing direction of drying gas; when the residual solvent content in webs is 70 to 130% by mass, the wind velocity of drying gas blown from a dryer is controlled to 0.5 to 20 m/sec at the surface of webs; when the residual solvent content in webs is 4 to 70% by mass, the web is dried by dry-gas wind blown at 5 to 40 m/sec, and the difference of the upper limit and the lower limit of temperatures is adjusted to no more than 10% of the upper limit, wherein the upper limit is defined from temperature distribution of drying gas in the width direction of webs; when the residual solvent content in webs is 4 to 200% by mass, the ratio q of drying gas amounts from upper and lower blowing suctions, situated lower and upper of webs, of driers is adjusted 0.2≦q≦1. It is also disclosed, as a preferable embodiment, that at least one species of gas is utilized for the drying gas, the average specific heat is 31.0 to 250 J/K·mol, and the drying is carried out using the drying gas that contains vapor of organic compounds, being a liquid at room temperature, at no more than 50% of saturated vapor pressure; these descriptions may be incorporated herein by reference.

JP-A No. 11-077719 discloses an invention in order to prevent deterioration of planarity or coating due to dusts or impurities in TAC producing apparatuses, in which clips of tenters are equipped with heating portions. It is also disclosed, as preferable embodiments, that devices are provided to remove foreign matter yielded at contact portions of clips and webs during from release of webs out of clips of tenters to re-support of webs; foreign matter is removed using a brush that injects a gas or liquid; residual content at contacting clips or pins and webs is 12 to 50% by mass; surface temperature of contact portions of clips or pins and webs is preferably 60° to 200°, more preferably 80° to 120°; these descriptions may be incorporated herein by reference.

JP-A No. 11-090943 discloses an invention in order to prevent quality degradation due to rapture in tenters and to enhance productivity in processes using tenter clips, in which Lr=Ltt/Lt is controlled to 1.0≦Lr≦1.99, where Lt (m) is an optional length of a tenter, Ltt (m) is a total length in conveying direction of web-supporting portions of a clip of which the tenter has the same length Lt. It is also disclosed, as a preferable embodiment, that web-supporting portions are disposed with no space viewed from the web-width direction; these descriptions may be incorporated herein by reference.

JP-A No. 11-090944 discloses an invention in order to prevent planarity degradation and unstable insertion due to relaxation of webs at introducing webs into tenters, in which a relaxation-suppressing device is provided at tenter inlets so as to prevent the relaxation in web-width direction. As still preferable embodiments, it is also disclosed that the relaxation-suppressing device is a roller that rotates in a direction of 2° to 60° and a blower is provided that blows from under the webs; these descriptions may be incorporated herein by reference.

JP-A No. 1′-090945 discloses an invention in order to inhibit quality degradation and relaxation harmful to productivity in TAC production, in which webs separated from supports are introduced into tenters with an angle from horizontal face; these descriptions may be incorporated herein by reference.

JP-A No. 2000-289903 discloses an invention in order to produce films with stable physical properties, in which a conveying device is provided that conveys separated webs while applying a tension in the width direction at the stage of 50 to 12% by mass of solvent content, the conveying device comprises a means configured to detect web width, a means configured to support webs, and variable two or more flexing sites, and the site of flexing portions is adjusted through detecting and computing the web width; these descriptions may be incorporated herein by reference.

JP-A No. 2003-033933 discloses a construction in order to enhance clipping properties, to prevent web breakage for a long period, and to produce films with excellent quality, in which a guide plate for preventing curling at web edges is disposed at the sites of at least one of upper or lower edges, and the guide-plate face opposing webs is constructed from resin portions and metal portions to contact with webs disposed in conveying direction of webs.

It is also disclosed, as preferable embodiments, that resin portions to contact with webs are disposed upstream in web-conveying direction and metal portions to contact with webs are disposed downstream; the gap between resin portions to contact with webs and metal portions to contact with webs is no more than 500 μm; the lengths in width direction to contact with webs of resin portions to contact with webs and metal portions to contact with webs are respectively 2 to 150 mm; the lengths in conveying direction to contact with webs of resin portions to contact with webs and metal portions to contact with webs are respectively 5 to 120 mm; resin portions to contact with webs are provided by surface processing or coating on metal guide substrates; resin portions to contact with webs are formed of a resin itself; the distance between the surfaces facing to webs of guide plates disposed upper and lower of both edges of webs is 3 to 30 mm; the distance between the surfaces facing to webs of guide plates disposed upper and lower of both edges of webs is enlarged 2 mm or more per 100 mm width in the width and inner direction; the upper and lower guide plates have a length of 10 to 300 mm at the both edges of webs, the upper and lower guide plates are disposed with a front-back deviance in the conveying direction, and the deviance distance is −200 to +200 mm; the surface facing to webs of upper guide plate is formed of a resin or metal itself; the resin portions to contact with webs of guide plate are formed of Teflon (trade mark), and metal portions to contact with webs are formed of a stainless steel; at least one of the resin portions and metal portions to contact with webs at the surface facing to webs has a surface roughness of 3 μm or less. It is also described that the guide plate for preventing curling at web edges is preferably disposed between the peeling-side edge of support and tenter-introduction portion, in particular near the tenter inlet is preferable; these descriptions may be incorporated herein by reference.

JP-A No. 11-048271 discloses an invention in order to prevent cutting or fluctuation of webs during drying in tenters, in which webs are stretched and dried when the solvent content is 12% to 50% by mass, and a pressure of 0.2 to 10 kPa is applied to webs from both sides when the solvent content is no more than 10% by mass. It is also described, as preferable embodiments, that the application of tension is ceased when the solvent content is 4% by mass or more; when a pressure is applied by use of nip rolls from both sides of webs or films, the pair of nip rolls are preferably employed for 1 to 8 sets, the temperature at the pressuring is preferably 100° C. to 200° C.; these descriptions may be incorporated herein by reference.

JP-A No. 2002-036266 discloses an invention in order to produce high-quality thinner tacks, as the preferable embodiments, the difference of tensions applied to webs at front and back of tenters along the conveying direction is set 8 N/mm² or less; the process comprises preheating webs after a peeling step, stretching webs using tenters after the preheating, and relaxing the webs after the stretching in a level less than the stretched level in the stretching step, the temperature T1 at the preheating and stretching is set as no less than Tg−60° C. (Tg: grass transition temperature of film) and the temperature T2 at the relaxing step is set as T1−10° C.; the stretch rate at the stretching step is set as 0% to 30% on the basis of the web width immediately before the stretching step, and the stretch rate at the relaxing step is set to −10% to 10%; these descriptions may be incorporated herein by reference.

JP-A No. 2002-225054 discloses an invention in order to make thinner i.e. 10 to 60 μm, to reduce weight and to improve moisture-permeability and durability, in which both edges of webs are gripped by clips and webs are stretched while preventing dry-shrinkage by supporting the edges till the residual solvent comes to 10% by mass, thereby to make the plane-orientation degree S into 0.0008 to 0.0020 (S=[(Nx+Ny)/2]−Nz, Nx: refractive index in the highest direction of in-plain film, Ny: refractive index in the perpendicular direction with Nx, Nz: refractive index in thickness direction); the period from the flow-casting to peeling is controlled into 30 to 90 seconds; the peeled webs are stretched in traverse or longitudinal direction; these descriptions may be incorporated herein by reference.

S={(Nx+Ny)/2}−Nz: Equation (IV)

JP-A No. 2002-341144 describes a film-forming method from a solution comprising a stretching step in order to suppress optical fluctuation, in which mass concentration of a retardation-increasing agent has an optical distribution such that the concentration is higher as approaching to the central portion in film-width direction; these descriptions may be incorporated herein by reference.

JP-A No. 2003-071863 discloses an invention in order to suppress haze, in which the stretching rate is preferably 0% to 100% in the width direction, and in cases utilized for protective films for polarizing plates, preferably 5% to 20%, particularly preferably 8% to 15%. It is also disclosed that the stretching rate is preferably 10% to 40%, more preferably 20% to 30% in cases utilized for phase-difference films; controlling Ro by the stretching rate and higher stretching rate are preferable for superior planarity of resulting films. It is also disclosed that the residual solvent content in the tenter process is preferably 20 to 100% by mass at starting the tenter, and preferably, films are dried with applying tenters till the residual solvent content comes to no more than 10% by mass, more preferably no more than 5% by mass. It is also disclosed that the drying temperature in the tenter process is preferably 30° C. to 150° C., more preferably 50° C. to 120° C., particularly preferably 70° C. to 100° C.; the lower is the drying temperature, the less is the evaporation of UV ray absorbers or plasticizers, thus reducing the process pollution, on the other hand, the higher is the drying temperature the more excellent is the planarity of films; these descriptions may be incorporated herein by reference.

JP-A No. 2002-248639 discloses an invention in order to reduce size fluctuation in the length and the width during reservation at higher temperatures and higher humidities, in which a film is produced by flow-casting a cellulose ester solution on a support, then continuously peeling and drying, the shrinkage rate at the drying is adjusted so as to satisfy the Equation (V) shown below.

It is also disclosed, as preferable embodiments, that the residual solvent content of peeled cellulose ester films is reduced no less than 30% by mass, while gripping the both ends of the films when the films have a residual solvent content of 40 to 100% by mass; the residual solvent content is 40 to 100% by mass at the tenter-conveyance inlet and the content at the outlet is 4 to 20% by mass; the tension to tenter-convey the cellulose ester films is adjusted to increase from the inlet to outlet of the tenter-conveyance; the tension to convey cellulose ester films under the tenter-conveyance is approximately the same as the tension in width direction of the cellulose ester films; these descriptions may be incorporated herein by reference.

0≦Shrinkage Rate (%)≦0.1×Residual Solvent Content at peeling (%): Equation (V)

JP-A No. 2000-239403 discloses a film-forming process in order to produce thin films with excellent optical isotropy and planarity, in which residual solvent content X at peeling and residual solvent content Y at introducing into tenters is controlled in the process as: 0.3X≦y≦0.9×.

JP-A No. 2002-286933 discloses stretching processes for flow-casting films, in which stretching processes under heating or solvent-containing conditions are employable, it is preferable that the stretching is carried out at a temperature lower than the glass transition temperature of resins in stretching processes under heating, on the other hand, when flow-cast films are stretched under solvent-containing conditions, it is possible that once-dried films are contacted again with a solvent to impregnate the solvent then the stretching is carried out.

### Retardation-Increasing Agent

### Retardation-Increasing Agent for Controlling Re

In order to control the absolute value of Re of the inventive protective film or optical compensation film, it is preferred that a compound having a maximum absorption wavelength (λmax) shorter than 250 nm in the UV absorption spectrum of the solution is employed for the retardation-increasing agent.

Such a compound may make possible to control the absolute value without substantially changing the wavelength dependency of Re in visible region. From the viewpoint of functions of the retardation-increasing agent, the compound is preferably a rod-like liquid crystal compound having at least an aromatic ring, more preferably at least tow aromatic rings.

It is preferred that the rod-like liquid crystal compounds have a linear molecular structure. The term “linear molecular structure” means that the molecular structure of the rod-like compounds is linear in the thermodynamically most stable structure. The thermodynamically most stable structure can be determined by crystalline structure analysis or molecular orbital methods.

For instance, the molecular orbital is calculated using a molecular-orbital software (e.g. WinMOPAC 2000, by FUJITSU), and the molecular structure can be determined in a way that the heat for forming the compound is the lowest.

The linear molecular structure means that the angle of molecular structure is no less than 140° in the thermodynamically most stable structure calculated by the way described above.

Preferably, the rod-like compounds exhibit a liquid crystal property. More preferably, the rod-like compounds exhibit a liquid crystal property upon heating, i.e. have a thermotropic liquid crystal property. Preferably, the liquid crystal phase is a nematic or smectic phase.

The rod-like compound may be those described in JP-A No. 2004-4550, but not limited to. Two or more of rod-like compounds may also be combined with, provided that the rod-like compounds each have a maximum absorption wavelength (λmax) shorter than 250 nm in the UV absorption spectrum of the solution.

The synthesis processes of the rod-like compounds are described in published literatures, for example, “Mol. Cryst. Liq. Cryst., vol. 53, p. 229 (1979)”, “Mol. Cryst. Liq. Cryst., vol. 89, p. 93 (1982)”, “Mol. Cryst. Liq. Cryst., vol. 145, p. 111 (1987)”, “Mol. Cryst. Liq. Cryst., vol. 170, p. 43 (1989)”, “J. Am. Chem. Soc., vol. 113, p. 1349 (1991)”, “J. Am. Chem. Soc., vol. 118, p. 5346 (1996)”, “J. Am. Chem. Soc., vol. 92, p. 1582 (1970)”, “J. Org. Chem. vol. 40, p. 420 (1975)”, “Tetrahedron, vol. 48, No. 16, p. 3437 (1992)”.

The content of the retardation-increasing agent is preferably 1 to 30% by mass based on the polymer, more preferably 0.5 to 20% by mass.

### Retardation-Increasing Agent for Controlling Rth

The retardation-increasing agent is preferably employed in order to generate a desirable Rth.

The “retardation-increasing agent” herein means additives in which a Re retardation value of a cellulose acylate film containing an additive measured at wavelength 550 nm is 20 nm or more higher than the Re retardation value of the cellulose acylate film prepared in the same way except for not containing the additive measured at wavelength 550 nm.

Preferably, the increase of the retardation value is 30 nm or more, more preferably 40 nm or more, particularly preferably 60 nm or more.

It is preferred that the retardation-increasing agent is a compound containing at least two aromatic rings. The content of the retardation-increasing agent is preferably 0.01 to 20 parts by mass based on 100 parts by mass of polymers, more preferably 0.1 to 10 parts by mass, still more preferably 0.2 to 5 parts by mass, most preferably 0.5 to 2 parts by mass. Two or more species of retardation-increasing agents may be used together with.

It is preferred that the retardation-increasing agent exhibits a maximum absorption at a wavelength range of 250 to 400 nm and exhibits substantially no absorption at visible range.

In addition, it is preferred that the retardation-increasing agent for controlling Rth gives no effect on Re generated through stretching and is a disc-like compound.

The “disc-like compound” herein may have an aromatic hetero ring in addition to an aromatic hydrocarbon ring; preferably, the aromatic hydrocarbon rings are six-membered rings or benzene rings.

The aromatic hetero rings are typically unsaturated hetero rings. The aromatic hetero rings are preferably five-membered rings, six-membered rings or seven-membered rings, more preferably five-membered rings or six-membered rings. The aromatic hetero rings have typically the highest number of double bonds.

The hetero atom is preferably a nitrogen atom, oxygen atom or sulfur atom, particularly preferably nitrogen atom. Examples of the hetero rings include furan ring, thiophene ring, pyrrole ring, oxazole ring, isooxazole ring, thiazole ring, isothiazole ring, imidazole ring, pyrazole ring, furazan ring, triazole ring, pyran ring, pyridine ring, pyridazine ring, pyrimidine ring, pyrazine ring and 1,3,5-triazine ring.

Preferable aromatic rings are benzene ring, furan ring, thiophene ring, pyrrole ring, oxazole ring, thiazole ring, imidazole ring, triazole ring, pyridine ring, pyrimidine ring, pyrazine ring and 1,3,5-triazine ring; particularly preferable is 1,3,5-triazine ring. Specifically, the compounds disclosed in JP-A No. 2001-166144 are preferably utilized.

The amount of the aromatic compounds is 0.01 to 20 parts by mass based on 100 parts by mass of the cellulose acylate, more preferably 0.05 to 15 parts by mass, still more preferably 0.1 to 10 parts by mass. Two or more compounds may be combined with.

### Control of Rth by Optically Anisotropic Layer

It is preferred that an optically anisotropic layer such as liquid crystal layers is coated through a coating process so as to control the Rt without affecting Re which being generated through stretching.

As for specific examples, a discotic compound is oriented such that the angle between the disc face and the optical compensation-film face is restricted to less than 5° (JP-A No. 10-312166), a rod-like compounds is oriented such that the angle between the long axis and the face of the optical compensation film is restricted to less than 5° (JP-A No. 2000-304932).

### Mechanism of Optical Compensation

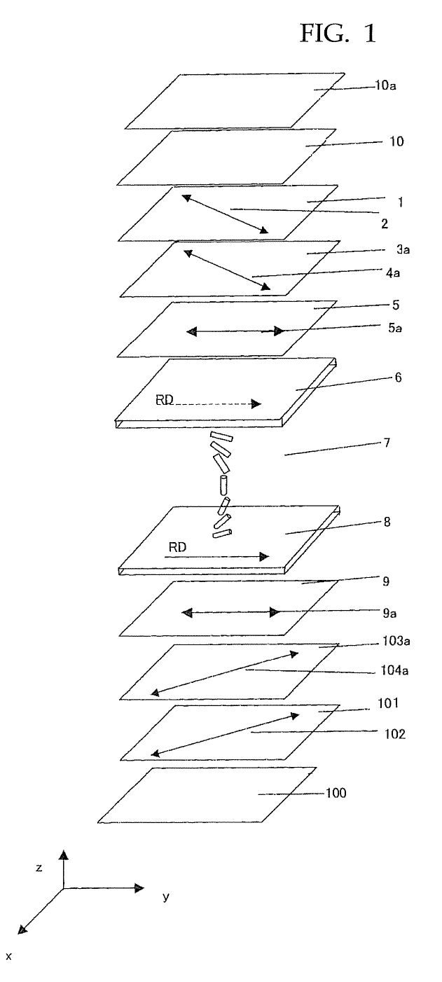

The mechanism of optical compensation by the inventive polarizing plate will be explained with reference to FIG. 1, which shows a construction of an inventive liquid crystal display device. The crystal display device of OCB mode, as shown in FIG. 1, is comprised of a liquid crystal cell and two polarizing plates that are disposed on both sides of the liquid crystal cell to sandwich it.

The liquid crystal cell is comprised of a liquid crystal layer 7, of which the liquid crystal molecule undergoing a bend orientation to the substrate face upon voltage application i.e. at black display, and substrates 6 and 8 that sandwich it. The substrates 6 and 8 are orientation-treated at their liquid crystal faces, and the rubbing directions are indicated by arrow marks.

The polarizing plates are formed by grasping polarizing films 1, 101 with two supports; one of the supports is cellulose acylate films 3a, 103; and optically anisotropic layers 5, 9 are disposed on the support through an orientation film (not shown); a moisture permeability-control layer 10a is disposed on the other species of the supports as a protective film 10.

The polarizing films 1, 101 are sandwiched between cellulose acylate films 3a, 103a and protective film 10, in which the surface of the cellulose acylate films opposite to the optically anisotropic layers 5, 9 faces and also the surface of the protective layer 10 opposite to the moisture permeability-control layer 10a faces the polarizing films 1, 101. That is, optically anisotropic layers 5 (9), orientation films (not shown), cellulose acylate films 3a (103a), polarizing films 1 (101), protective film 10 and moisture permeability-control layer 10a are disposed in order on the liquid crystal cell.

The transmission axes 2, 102 of the polarizing films 1, 101 are perpendicular each other, and are each inclined 45° from the RD direction of the liquid crystal layer 7 of the liquid crystal cell.

The phase-delay axes 4a, 104a of the cellulose acylate films 3a, 103a are respectively parallel to the adjacent transmission axes 2, 102 of the polarizing films 1, 101. The optically anisotropic layers 5, 9 represent optical anisotropy that is expressed by the orientation of the liquid crystal compound.

The liquid crystal cell in FIG. 1 is comprised of an upper substrate 6, a lower substrate 8, and a liquid crystal layer 7 of liquid crystal molecule interposed therebetween.

Orientation films (not shown) are formed on the surfaces (hereinafter sometimes referred to as “inner surface”) of substrates 6, 8, which contacting with liquid crystal molecule, that control the orientation of liquid crystal molecule in parallel direction with a pretilt angle at conditions of no or low voltage.

In addition, transparent electrodes (not shown) are provided at inner surfaces of the substrates 6, 8, capable of applying a voltage to the liquid crystal layer 7 of the liquid crystal molecule.

It is preferred in the present invention that the product Δn·d, in which Δn being refractive index anisotropy and “d” being thickness of the liquid crystal layer (μm), is 0.1 to 1.5 μm, more preferably 0.2 to 1.5 μm, still more preferably 0.2 to 1.2 μm, particularly preferably 0.6 to 1.1 μm. The range described above may lead to display devices with higher brightness and contrast due to higher white luminance at applying a voltage for white display.

The employable liquid crystal materials are those having a positive permittivity anisotropy so that the liquid crystal molecule 7 responds in parallel with the electric field direction in cases where an electric field is applied between lower and upper substrates 6, 8.

In cases that the liquid crystal cell is of OCB mode, nematic liquid crystal materials, having a positive permittivity anisotropy with Δn=0.16 and Δε=5 or so, may be employable between the lower and upper substrates 6, 8 of.

The thickness “d” of the liquid crystal layer may be about 4 μm, for example, when liquid crystals having a property within the range described above are employed.

In accordance with the present invention, the brightness at white display depends on the product Δn·d of the refractive index anisotropy and the thickness of the liquid crystal layer; therefore, it is preferred that the Δn·d is designed to be 0.5 to 1.5 μm at applying no voltage, in order to display sufficient brightness at applying a voltage of white display.

Chiral materials, typically utilized in liquid crystal displays of TN mode and scarcely utilized in those of OCB mode, may be optionally added in order to prevent insufficient orientation.

In addition, multidomain structure may be advantageous for arranging the orientation of liquid crystal at boundary region between domains; in which, the multidomain structure refers to a structure where one pixel in liquid crystal displays is divided into plural regions.

For example, the multidomain structure is advantageous in OCB mode from the viewpoint that brightness and/or color tone may be improved with respect to view angle dependency.

Specifically, constituting and averaging two or more regions, preferably 4 or 8, having different initial orientation conditions of each molecule in the pixels may mitigate the fluctuation of brightness and/or color tone due to view angles.

Similar effects may be taken by constituting the respective pixels from two or more different regions where the orientation direction of liquid crystal molecules changes continuously upon applying a voltage.

In the inventive optical compensation films 3a, 103a (cellulose acylate films 3a, 103a having the orientation film (not shown)), Re₍₄₅₀ₙₘ₎/Rth₍₄₅₀ₙₘ₎, which being a ratio of Re/Rth at wavelength 450 nm, is 0.4 to 0.95 time of the Re₍₅₅₀ₙₘ₎/Rth₍₅₅₀ₙₘ₎ at wavelength 550 nm, Re₍₆₅₀ₙₘ₎/Rth₍₆₅₀ₙₘ₎, which being a ratio of Re/Rth at wavelength 650 nm, is 1.05 to 1.93 times of the Re₍₅₅₀ₙₘ₎/Rth₍₅₅₀ₙₘ₎ at wavelength 550 nm, and Rth is 0 to 300 nm.

The optical compensation films 3a, 103a may serve as supports of optical compensation layers 5, 9 and/or protective films of polarizing films 1, 101.

That is, the polarizing film 1, optical compensation film 3a, and optically anisotropic layer 5, and/or the polarizing film 101, optical compensation film 103a, and optically anisotropic layer 9 may be incorporated into the optical display device in a form of an integrated laminate or as individual members.

A protective film for the polarizing film may be disposed between the optical compensation film 3a and the polarizing film 1 or between the optical compensation film 103a and the polarizing film 101; preferably, no protective film is disposed therebetween.

It is preferred that the phase-delay axis 4a of the optical compensation film 3a and the phase-delay axis 104a of the optical compensation film 103a are substantially parallel or perpendicular each other.

When the phase-delay axis 4a of the optical compensation film 3a and the phase-delay axis 104a of the optical compensation film 103a are perpendicular each other, the optical properties of lights entering perpendicularly into liquid crystal display devices may be less degraded, since birefringence of the respective optical compensation film may be canceled each other.

When the phase-delay axes 4a, 104a are parallel each other and there exist a residual phase difference at the liquid crystal layer, the phase difference may be compensated by the birefringence of the protective film.

The transmission axis 2 of the polarizing film 1, the transmission axis 102 of the polarizing film 101, the phase-delay axis 4a of the optical compensation film 3a, the phase-delay axis 104a of the optical compensation film 103a and the orientation direction of the liquid crystal molecule 7 may be optimally arranged depending on the materials of the members, display modes and laminate structures of the members. Namely, the transmission axis 2 of the polarizing film 1 and the transmission axis 102 of the polarizing film 101 are arranged perpendicularly each other, but the liquid crystal display device of the present invention will be not limited to.

The optically anisotropic layers 5, 9 are disposed respectively between the optical compensation films 3a, 103a and the liquid crystal cell. The optically anisotropic layers 5, 9 are ones formed from a liquid crystal compound, e.g. a composition containing a rod-like compound or disc-like compound.

In the optically anisotropic layers 5, 9, the molecule of the liquid crystal compound is fixed at a certain orientation condition. The average orientation directions 5a, 9a of molecular symmetrical axes of the liquid crystal compound in the optically anisotropic layers 5, 9 intersect respectively with the phase-delay axes 4a, 104a of the optical compensation films 3a, 103a at an angle of about 45° at least at the interface on the sides of the optical compensation films 3a, 103a.

Such an arrangement may prevent light leakage due to retardation of incident light from normal direction induced by the optically anisotropic layer 5 or 9, and the effects of the present invention may be sufficiently attained for incident lights from inclined or oblique directions.

It is also preferred that the average orientation directions of molecular symmetrical axes of the liquid crystal compound in the optically anisotropic layers 5, 9 intersect with the in-plane phase-delay axes 4a, 104a of the cellulose acylate films 3a, 103a at an angle of about 45°.

It is also preferred that the average orientation direction 5a of molecular symmetrical axes of the liquid crystal compound in the optically anisotropic layers 5 intersects with the transmission axis 2 of the adjacent polarizing film 1 at an angle of about 45° at the polarizing film side or at the interface side of the optical compensation film.

Similarly, it is also preferred that the average orientation direction 9a of molecular symmetrical axes of the liquid crystal compound in the optically anisotropic layers 9 intersects with the transmission axis 102 of the adjacent polarizing film 101 at an angle of about 45° at the polarizing film side or at the interface side of the optical compensation film.

Such an arrangement may allow optical switching depending on the sum of the retardations due to the optically anisotropic layer 5 or 9 and the retardation of the liquid crystal layer, which may result in sufficient effects of the present invention for incident lights from inclined directions.

### Principle of Image Display

The principle of image display will be explained with reference to the liquid crystal display device shown in FIG. 1.

In a driving state at which a driving voltage, corresponding to black display, is applied to respective transparent electrodes (not shown) of substrates 6, 8, the liquid crystal molecule 7 in the liquid crystal layer undergoes a bend orientation, the in-plane retardation is canceled with the retardation of the in-plane retardation of the optically anisotropic layers 5 and 9, consequently, the incident light scarcely changes its polarization condition.

The transmission axis 2 of the polarizing film 1 and the transmission axis 102 of the polarizing film 101 are perpendicular each other, therefore, the incident light from lower side, e.g. from a back electrode, is polarized by the polarizing film 101, then transmits through the substrates 6, 8 while maintaining the polarized condition, and is interrupted by the polarizing film 1. That is, the liquid crystal display device shown in FIG. 1 may represent an ideal black display at its driving state.

On the other hand, in a driving state at which a driving voltage, corresponding to white display, is applied to transparent electrodes (not shown), the liquid crystal molecule 7 in the liquid crystal layer undergoes a bend orientation different from that at the black display, thus the in-plane retardation comes to different from that at the black display.

Consequently, the in-plane retardation is not canceled by the optically anisotropic layers 5, 9, thus the light changes the polarization state while passing through the substrates 6, 8 and then transmits the polarizing film 1, resulting in white display.

Conventionally, there exists a problem in OCB mode that the contrast is lower in oblique directions even thought the front contrast being higher. Higher contrast may be typically obtained at black display by virtue of the compensation between the liquid crystal cell and the optically anisotropic layer at front side, whereas birefringence and polarization-axis rotation are induced in the liquid crystal molecule when being observed from oblique directions. Furthermore, the intersection angle between the transmission axis 2 of the polarizing film 1 and the transmission axis 102 of the polarizing film 101, which being 90° from a front side, typically departs from 90° in oblique directions.

Conventionally, these two factors cause a problem that the light leaks at oblique directions, resulting in lower contrast. For the countermeasure, the inventive liquid crystal display device shown in FIG. 1 employs the optical compensation film 3a or 103a, which having different Re/Rth in R, G and B and certain satisfactory optical properties, thus the light leakage is mitigated in oblique directions at black display and the contrast is improved.

More specifically, the present invention may make possible to optically compensate by action of the phase-delay axes and retardation, which being different depending on the wavelengths, for the lights of wavelengths R, G and B entering from oblique directions, by use of the optical compensation film with the optical properties described above.

In addition, the optically anisotropic layers 5, 9 in FIG. 9, of which the orientation of liquid crystal compound being fixed, are disposed in a way that the average orientation direction of molecular symmetrical axes of the liquid crystal compound in the optically anisotropic layer intersects with the phase-delay axis of the optically anisotropic layer at an angle of 45°, thereby making possible to conduct the compensation, in a particular way for OCB orientation, with respect to entire wavelengths.

As a result, the black display may be remarkably improved in terms of contrast and view-angle dependency, and the coloring may be considerably mitigated at black display depending on view angles.

In particular, there often appears coloring difference of right-left asymmetry when view angle being changed along a horizontal direction e.g. at polar angle 60° and azimuthal angles 0° to 180°, which may be improved significantly.

In this specification, the wavelengths of R, G and B are 650 nm, 550 nm and 450 nm respectively. These wavelengths of R, G and B, which being unnecessary to be restricted definitely, are believed to be appropriate to determine the optical properties in the present invention.

In the present invention, the ratio of Re/Rth is employed as a noticeable factor, since the value of Re/Rth determines the two specific polarization axes of light that propagates through a two-axis birefringence medium in an oblique direction. The two specific polarization axes of light, propagating through the two-axis birefringence medium, corresponds to long axis and short axis of a cross-section, cut perpendicular to the light-propagating direction, of an index ellipsoid.

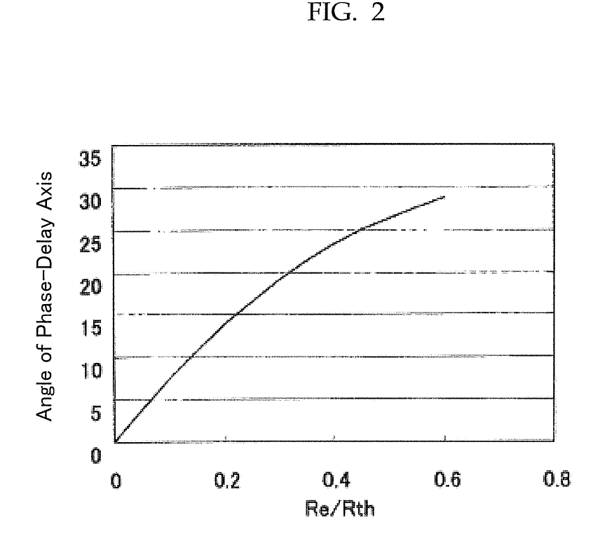

FIG. 2 exemplarily shows a calculation between angles of phase-delay axis, one of the two specific polarization axes, and Re/Rth, in a case that light enters from oblique directions into the optical compensation film in the present invention.

In the calculation of FIG. 2, the light-propagating direction is assumed as azimuthal angle 45° and polar angle 34°. As shown in FIG. 2, the angle of phase-delay axis is principally determined by Re/Rth without depending on the wavelength of incident light. The change of polarizing condition of incident light through transmitting the optical compensation film generally depends on the phase-delay axis direction and retardation of the optical compensation film; whereas, in the prior art, the values of Re/Rth are substantially the same, that is, the phase-delay axis angles are substantially the same, regardless of the wavelengths of R, G and B.

On the contrary in the present invention, both of the phase-delay axis and retardation, which being main factors for the polarizing-condition change, are optimized at wavelengths R, G and B by defining Re/Rth separately at wavelengths R, G and B.

Then the values of Re/Rth of the optical compensation film are arranged depending on the wavelengths such that deviation of the retardation and the apparent transmission axis of upper and lower polarizing films from front side may be simultaneously compensated at every wavelengths when the light transmits through the optical compensation film at an oblique angle, through the optically anisotropic layer, of which the liquid crystal compound being fixed for the orientation, then through a liquid crystal layer of a bend orientation.

Specifically, by way of making larger the Re/Rth of the optical compensation film along with the wavelength being larger, it may make possible to eliminate the polarization difference at R, G and B due to wavelength dispersion in the optically anisotropic layer and the liquid crystal layer.

As a result, the compensation may be made substantially perfect and the contrast decrease may be mitigated. When film parameters are determined for the entire visible region by the representative R, G and B, the compensation may be substantially perfect over the entire visible region.

The “polar angle” and “azimuthal angle” are defined as follows: the “polar angle” is a tilt angle from the normal line of the optical compensation-film surface, i.e. Z axis in FIG. 1; for example, the direction of the normal line of the optical compensation-film surface is the direction of “polar angle=0°”. The “azimuthal angle” expresses an anticlockwise direction from the positive direction of X axis; for example, the positive direction of X axis corresponds to “azimuthal angle=0°”, and the positive direction of Y axis corresponds to “azimuthal angle=90°”. At the oblique direction where light escape is most serious, the polarization axis of the polarizing layer is ±45°, therefore, such cases will be mainly explained in this specification as azimuthal angle=0°, 90°, 180° or 270°, and polar angle ≠0°.

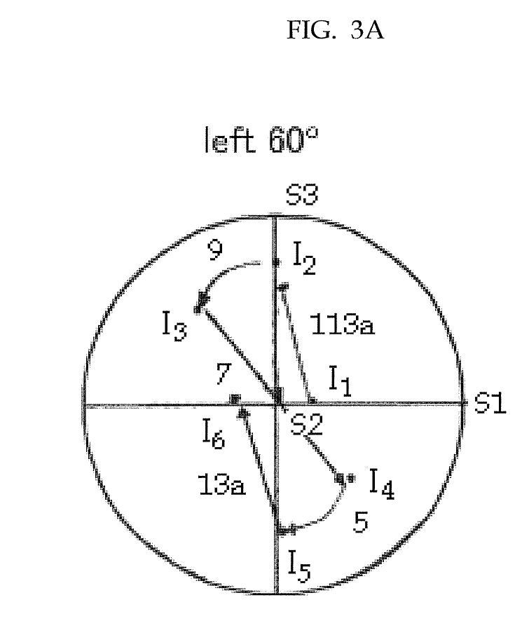

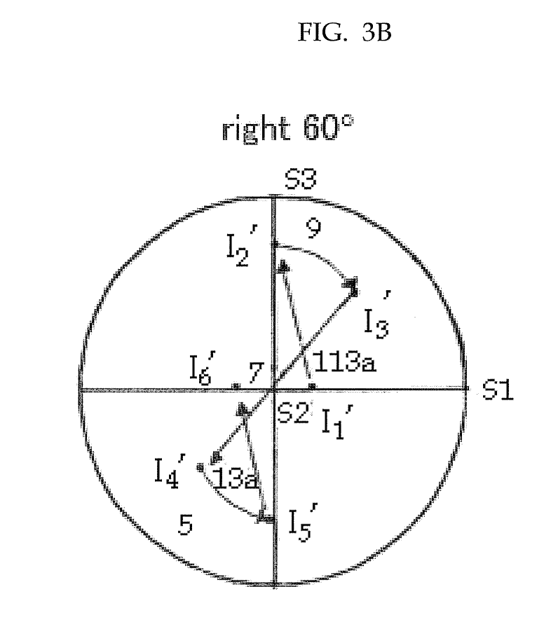

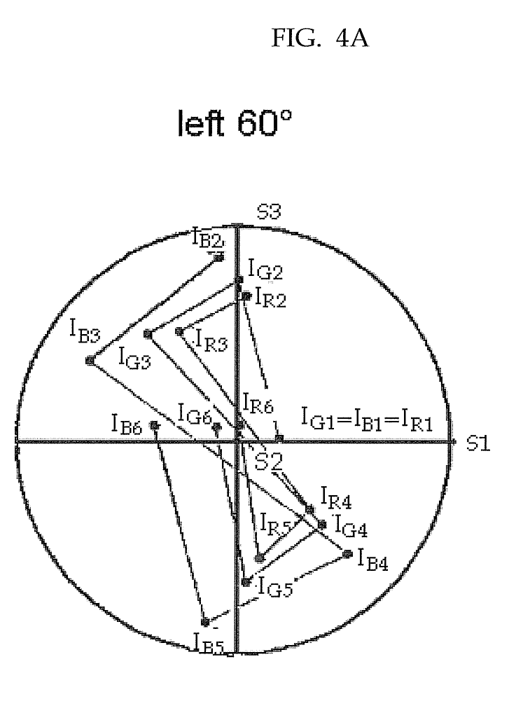

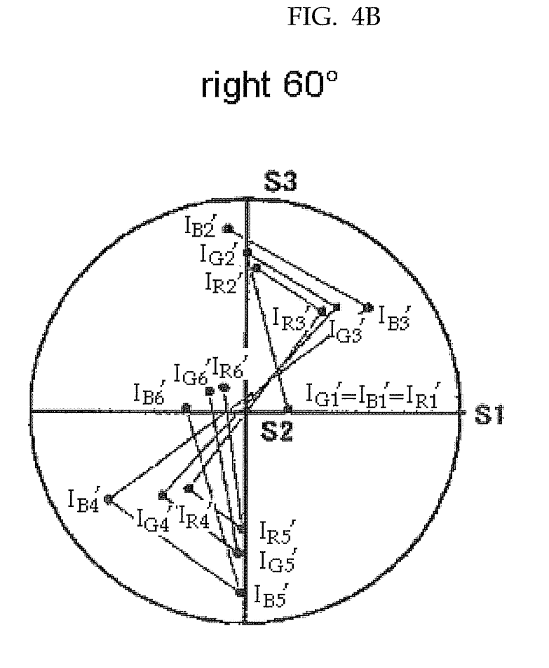

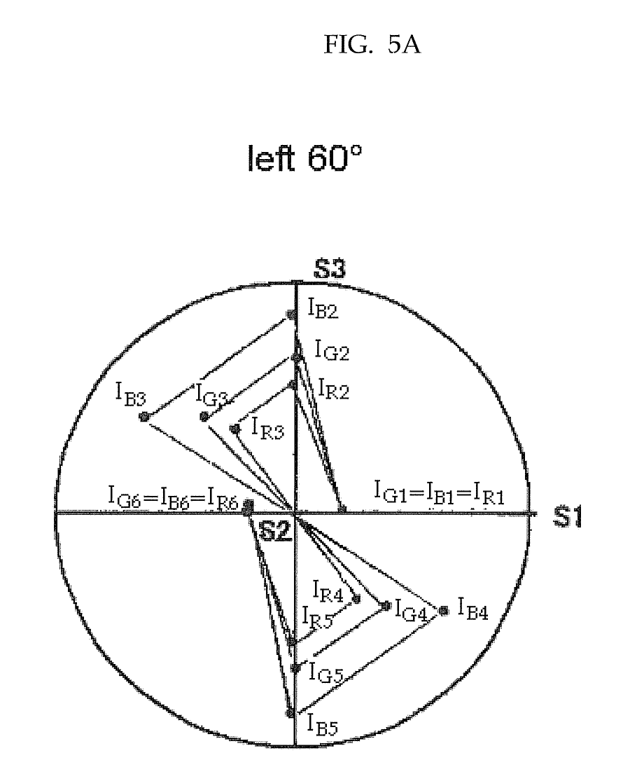

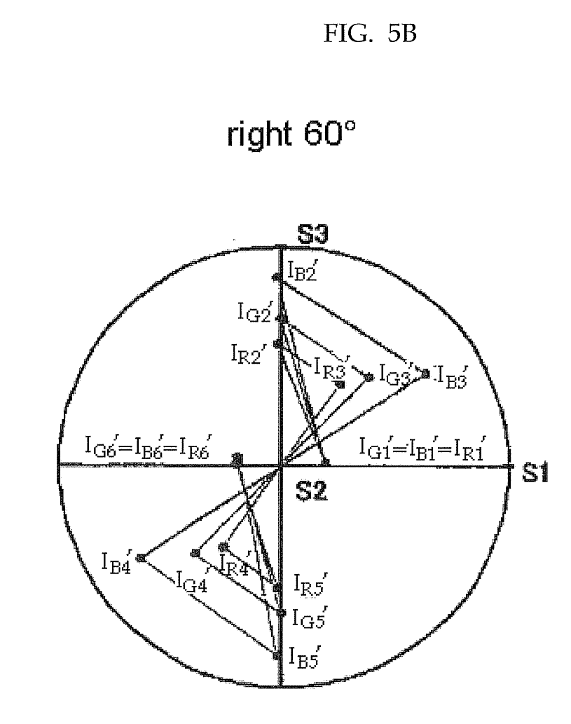

In order to explain the inventive effects in detail, the polarization condition of an incident light into a liquid crystal display device is expressed on Poincare sphere as shown in FIG. 3. S2 axis in FIG. 3 is the axis extending this paper plane perpendicularly from front to back, and FIG. 3 shows a view of the Poincare sphere from the positive direction of the S2 axis. FIG. 3 is expressed two-dimensionally, therefore, displacements of sites before and after change of polarization conditions are expressed by linear arrows; actually, the change of polarization conditions caused by transmitting through liquid crystal layers or optical compensation films is expressed, on the Poincare sphere, by rotation of certain angle around a specific axis that is determined depending on the optical properties, as shown in FIGS. 4 and 5.

FIG. 3A shows a change of polarization condition in terms of G light entered from left 60° into the liquid crystal display device shown in FIG. 1, and FIG. 3B shows a change of polarization condition in terms of G light entered from right 60°. The optical properties of optical compensation films 3a, 103a and optically anisotropic layers 5, 9 are calculated under the same conditions with those of the Poincare sphere shown in FIG. 3B as described later. G light entered from left 60° causes a change in the polarization condition as shown by points on the Poincare sphere in FIG. 3A.

Specifically, the polarization condition I1 of the G light after transmitting through the polarizing film 101 turns to I2 after transmitting through the optical compensation film 103a, to I3 after transmitting through the optically anisotropic layer 9, to I4 after transmitting through the liquid crystal layer 7 of liquid crystal cell at black display, to I5 after transmitting through the optical compensation film 5, and to I6 after transmitting through the optical compensation film 3a, and then the G light is shielded by the polarizing film 1 and ideal black is displayed.

On the other hand, G light entered from right 60° changes the polarization conditions as I1′, I2′, I3′, I4′, I5 and I6′ in order. With respect to the change of polarization conditions, the lights entered from left 60° and right 60° exhibit a mirror symmetry after transmitting through the optically anisotropic layer 9, the optically anisotropic layer 5, and the liquid crystal layer 7, meanwhile, the lights entered from left 60° and right 60° exhibit the same polarization condition after transmitting through the optical compensation films 103a, 11a. In order to mitigate the light escape at black display and color shift in left-right direction, it is necessary that the compensation condition is satisfied for right and left sides simultaneously and for every wavelength. That is, it is necessary that the sites of 16 and 16′ coincide and the lights of the polarization condition are shielded at the sites by the polarizing film 1 for not only the G light but also R (red) and B (blue) incident lights. Although the transitions described above are expressed using linear lines in FIG. 3, the transitions on the Poincare sphere are not limited to linear ones.

In the construction of liquid crystal display devices of conventional OCB mode, including the construction shown in JP-A No. 11-316378, the optical compensation films 3a, 103a where Re/Rth represents the wavelength dependency are not arranged, instead the optically anisotropic layer 5, and transparent supports 103a, 3a of the optically anisotropic layer 9 are supported. The transparent supports 103, 3 serve to support the optically anisotropic layers 5, 9, and are made of conventional polymer films.

Accordingly, Re/Rth is far from wavelength dependency such as of the optical compensation films 3a, 103a, and Re and Rth are substantially the same for all wavelengths of R, G and B.

As a result, the conventional liquid crystal display devices of OCB mode tend to cancel the front retardations of liquid crystal cells and optically anisotropic layers at front side at black display, thus there exists a problem that the light escape at black display cannot be prevented completely in oblique directions, even though black display can be taken. In addition, there also exist problems in terms of insufficient view angle contrast and coloring due to unsatisfactory compensation at every wavelength.

For purpose of more detail explanation, the calculation of polarization conditions for R, G and B lights entered into the conventional liquid crystal display device of OCB mode shown in FIG. 1 is represented on the Poincare sphere of FIG. 4A, 4B. FIG. 4A is a view that shows the changes of polarization condition of lights R, G and B entered from left 60°, and FIG. 4B is a view that shows the changes of polarization condition of lights R, G and B entered from right 60°.

In FIG. 4A, the polarization condition of incident light R is expressed as IR, the polarization condition of incident light G is expressed as IG, and the polarization condition of incident light B is expressed as IB. As for the conventional liquid crystal display device of OCB mode, the calculation is on the assumption as follows: Re=45 nm and Rth=160 nm for the transparent supports 3, 103 at every wavelength R, G, B, and Re=30 nm for the optically anisotropic layers 5, 9.

In FIG. 4A, 4B, the polarization conditions IR1, IG1, IB1 after transmitting through the polarizing film 101 are substantially identical. Concerning the polarization conditions of B light, it is understood that B light entered from left 60° represents, after transmitting through the transparent support 103, polarization condition IB2, which shifts to the same direction as the transition direction after transmitting through the optically anisotropic layer 9, and B light entered from right 60° represents, after transmitting through the transparent support 103, polarization condition IB2′, which shifts to the reverse direction as the transition direction after transmitting through the optically anisotropic layer 9.

That is, the light entered from left side and the light entered from right side undergo different effects on the polarization conditions from the transparent substrate 103. As a result, the sites of ultimate transition states IR6, IG6, IB6 of incident lights R, G, B from left 60° and the sites of ultimate transition states IR6′, IG6′, IB6′ of incident lights R, G, B from right 60° are considerably different rather than slightly different. Therefore, light escape and color shift are induced in left-right direction, which have been difficult to improve at the same time in the prior art.

In accordance with the present invention, the light escape and the color shift in left-right direction are improved at the same time in liquid crystal display devices of OCB mode by way of disposing an optical compensation film with specific optical properties. For purpose of more detail explanation, the calculation of polarization conditions for R, G, B lights transmitting through the conventional liquid crystal display device of OCB mode shown in FIG. 1 is represented on the Poincare sphere of FIG. 5A, 5B. FIG. 5A is a view that shows the changes of polarization condition of lights R, G, B entered from left 60°, and FIG. 5B is a view that shows the changes of polarization condition of lights R, G, B entered from right 60°. In FIG. 5A, 5B, the polarization condition of incident light R is expressed as IR, the polarization condition of incident light G is expressed as IG, and the polarization condition of incident light B is expressed as IB.

In the calculation for optical compensation films 3, 103, it is assumed that the ratio of Re/Rth at wavelength 450 nm: Re₍₄₅₀ₙₘ₎/Rth₍₄₅₀ₙₘ₎ is 0.17, the ratio of Re/Rth at wavelength 550 nm: Re₍₅₅₀ₙₘ₎/Rth₍₅₅₀ₙₘ₎ is 0.28, the ratio of Re/Rth at wavelength 650 nm: Re₍₆₅₀ₙₘ₎/Rth₍₆₅₀ₙₘ₎ is 0.39, and Rth at wavelength 550 nm is 160 nm. The Re of the optically anisotropic layers 5, 9 is assumed to be identical with that of the Poincare sphere of FIG. 3A.

As shown in FIG. 5A, 5B, lights R, G, B entered from light and left sides turn into the polarization conditions at the sites, which being near S1=0 and being sifted by reflecting the wavelength-dependent Re/Rth of the optical compensation film 103a, after transmitting through the optical compensation films 3a, 103a.

The shift may make possible to cancel the polarization-condition shifts that the lights R, G, B undergo by wavelength dispersion due to optically anisotropic layers 9, 5 and liquid crystal layer 7.

As a result, lights entered from both of left and right directions can take the ultimate transition point at a same site regardless of their wavelengths. Consequently, light escape at black display and color shift in left-right direction can be improved at the same time.

In accordance with the present invention, cellulose acylate film, which representing retardation-wavelength dispersion that is different for incident angle, for example, between normal direction and an oblique angle such as polar angle 60°, is utilized in a positive manner for optical compensation, thereby light escape at black display and color shift in left-right direction can be improved at the same time.

The scope of the present invention may be applied to liquid crystal display devices having liquid crystal layers of VA, IPS, ECB, TN modes, without being limited to specific display mode, as long as based on such a principle.

In addition, the liquid crystal display device according to the present invention is not limited to the construction shown in FIG. 1 and may contain other members, for example, a color filter may be disposed between the liquid crystal cell and the polarizing film.

In cases where the liquid crystal display device according to the present invention is used for transmission type, a back light with an optical source of cold cathodes, hot cathode fluorescent tubes, light-emitting diodes, field emission elements, or electro luminescent elements may be disposed at the back side.

The liquid crystal display device according to the present invention may be direct view, image projection, or light modulation type. The present invention may be advantageously applied to active matrix liquid crystal display devices having three or two terminal semiconductor elements such as TFT and MIM, and also to passive matrix liquid crystal display devices represented by STN so-called time division driving.

### Application for Optical Compensation Film

The optical compensation film to achieve the optical compensation will be explained below. The optical compensation film according to the present invention may contribute to enlarge view-angle contrast of liquid crystal display devices of OCB or VA mode in particular and to mitigate color shift due to view-angle dependency.

The optical compensation film according to the present invention may be disposed between the front polarizing plate and the liquid crystal cell, or between the rear polarizing plate and the liquid crystal cell, alternatively, the both ones are allowable.

The optical compensation film according to the present invention may, for example, be equipped into liquid crystal display devices as an independent member or as a member of polarizing plates by way of providing the protective film with an optical property thereby to function as a transparent film.

The optical compensation film according to the present invention may have at least two layers of another inventive optical compensation film and an optically anisotropic film with other optical properties.

### Other Optically Anisotropic Film

The optical compensation film according to the present invention has at least one optically anisotropic film, formed from a liquid crystal compound, in accordance with the intended liquid crystal type. The optically anisotropic film may be disposed directly on the surface of the optical compensation film or on an orientation film disposed on the optical compensation film. In addition, the optical compensation film according to the present invention may be prepared through transferring a liquid crystal-compound layer on another substrate on to an optical compensation film using a tackiness agent or adhesive.

The liquid crystal compound may be one of rod-like or discotic liquid crystal compounds (hereinafter a disc-like liquid crystal compound is sometimes referred to as a “discotic liquid crystal compound”). The rod-like or discotic liquid crystal compounds may be polymers or lower-molecular weight liquid crystals. The compounds in the resultant optically anisotropic layers may be of non-liquid crystal; specifically, such cases are allowable that lower molecular weight compounds are utilized to prepare optically anisotropic layers and the lower molecular weight compounds lose the liquid crystalline state.

### Rod-Like Liquid Crystal Compound

The rod-like liquid crystal compound may be azomethines, azoxys, cyanobiphenyls, cyanophenylesters, benzoic esters, cyclohexane carboxylic phenylesters, cyanophenylcyclohexanes, cyano-substituted phenylpyrimidines, alkoxy-substituted phenylpyrimidines, phenyldioxanes, tolanes, and alkenyl cyclohexylbenzonitriles.

The rod-like liquid crystal compounds may be a metal complex or an liquid-crystal polymer that contains the portion of rod-like liquid crystal compounds as a repeating unit.

The rod-like liquid crystal compounds are described, for example, in “Kikan Kagaku Review, vol. 22, Liquid Crystal Chemistry (1994), Japanese Chemical Society, Chapter 4, 7 and 11”, and “Liquid Crystal Device Handbook chapter 3, by Japan Society for the Promotion of Science, 142th committee”.

The birefringence index of rod-like liquid crystal compounds is preferably 0.001 to 0.7. It is preferred that the rod-like liquid crystal compounds have a polymerizable group in order to fix the orientation condition. Preferable polymerizable groups are unsaturated polymerizable groups or epoxy groups, more preferable are unsaturated groups, and particularly preferable are ethylenically unsaturated polymerizable groups.

### Discotic Liquid Crystal Compound

Examples of the discotic liquid crystal compounds include benzene derivatives described in “C. Destrade et al., Mol. Cryst. vol. 71, p. 111 (1981)”, toluxene derivatives described in “C. Destrade et al., Mol. Cryst. vol. 122, p. 141 (1985)” and “Physics Lett. A, vol 78, p. 82 (1990)”, cyclohexane derivatives described in “B. Kohne et al., Angew. Chem. vol. 96, p. 70 (1984)”, and aza crowns and phenylacetylene macrocycles described in “J. M. Lehn, J. Chem. Commun., p. 1794 (1985)” and “J. Zhang, J. Am. Chem. Soc. vol. 116, p. 2655 (1994).

The discotic liquid crystal compounds also encompass liquid crystal compounds having such a configuration that linear alkyl, alkoxy or substituted benzoyloxy groups are substituted as side chains radially around the parent nuclear of the molecular center. It is also preferred that the discotic liquid crystal compounds have a rotation symmetry as a whole and exhibit a certain orientation.

As described above, when an optically anisotropic layer is formed from the liquid crystal compound, the liquid crystal compound in the resulting optically anisotropic layer may turn into non-crystalline. In cases, for example, where low-molecular-weight discotic liquid crystal compounds have an optically or thermally sensitive group and the optically anisotropic layer is formed by polymerization, crosslinking or polymerization through the reaction of the optically or thermally sensitive group, compounds in the optically anisotropic layer may lose its liquid-crystalline properties. Favorable examples of the discotic liquid crystal compounds are described in JP-A No. 08-50206; the polymerization of the discotic liquid crystal compounds is described in JP-A No. 08-27284.

In order to fix the discotic liquid crystal compounds by polymerization, a polymerizable group should be attached as a substituent to a disc-like core of the discotic liquid crystal compounds. However, when the polymerizable group is bonded directly to disc-like cores, the orientation condition is hardly maintained through the polymerization reaction; therefore, it is preferred that a connecting group is introduced between a disc-like core and a polymerizable group.

In the present invention, the molecules in the optically anisotropic layer or of the rod-like compound or the disc-like compound are fixed in an oriented condition. The average orientation direction of molecular symmetrical axes of the liquid crystal compound intersects with the phase-delay axis of the optical compensation film at an angle of about 45° at the interface on the side of the optical compensation film. The term “about 45°” refers to the range of 45°±5°, preferably 42° to 48°, more preferably 43° to 47°.

The average-orientation direction of molecular symmetry axes of liquid crystal compounds may be usually adjusted by selecting materials of liquid crystal compounds or orientation films or by selecting rubbing-treatment processes.

In the present invention, for example, when an optical compensation film of OCB mode is to be produced, an orientation film for forming optically anisotropic layer is prepared through a rubbing treatment, then the resultant film is subjected to a rubbing treatment in a direction of 45° from the phase-delay axis of the optical compensation film, thereby an optically anisotropic layer having an average orientation direction of 45°, of molecular symmetry axes of the liquid crystal compound, from the phase-delay axis of cellulose acylate films may be obtained.

The optical compensation film of the present invention may be produced continuously, for example, by employing a long cellulose acylate film of which the phase-delay axis is perpendicular to the longitudinal direction.

More specifically, an long optical compensation film may be produced continuously by way of preparing a film by applying continuously a coating liquid for orientation film on a surface of optical compensation film, rubbing continuously the surface of the orientation film in a direction of 45° from the longitudinal direction, applying continuously a coating liquid for optically anisotropic layers containing a liquid crystal compound on the resulting orientation film, and aligning the molecules of the liquid crystal compound and fixing its condition. The resulting continuous long optical compensation film may be cut into a desirable shape before installing into liquid-crystal display devices.

As for the average orientation direction of molecular symmetry axes at the face side or air side of liquid crystal compounds, the average orientation direction is preferably about 0° and 45° from the phase-delay axis of optical compensation film, more specifically 42° to 48°, in particular 43° to 47°. The average orientation direction of molecular symmetry axes at air side of liquid crystal compounds may be adjusted by selecting additives of liquid crystal compounds. The additives utilized with liquid crystal compounds may be plasticizers, surfactants, polymerizable monomers, and polymerizable polymers. The deviation degree of orientation direction of molecular symmetry axes may be adjusted through selecting the liquid crystal compounds and additives. The surfactants are preferably compatible with surface tension of coating liquids described above.

It is preferred that the plasticizer, surfactant and polymerizable monomer utilized with the liquid crystal compounds are compatible with discotic liquid crystal compounds and able to change the inclination angle of the discotic liquid crystal compounds or affect no inhibition on the orientation. Examples of the polymerizable monomer are compounds having at least one of vinyl group, vinyloxy group, acryloyl group, and methacryloyl group. The amount of the compounds described above is usually 1 to 50% by mass based on liquid crystal compounds, preferably 5 to 30% by mass. When a polymerizable monomer having 4 or more of reactive functional groups is incorporated, the adhesion between orientation films and optically anisotropic layers may be enhanced.

When discotic liquid crystal compounds are employed for the liquid crystal compound, a polymer is preferably employed that has some compatibility with the discotic liquid crystal compounds and changes the inclination angle of the discotic liquid crystal compounds.

Examples of the polymer include cellulose esters. The cellulose esters are exemplified by cellulose acetate, cellulose acetate propionate, hydroxypropyl cellulose and cellulose acetate butylate.

The amount of the polymer is preferably 0.1 to 10% by mass based on discotic liquid crystal compounds, more preferably 0.1 to 8% by mass, particularly preferably 0.1 to 5% by mass so as not to disturb the alignment of discotic liquid crystal compounds.

The transition temperature of liquid-crystal phase/solid phase of discotic liquid crystal compounds into discotic nematic is preferably 70° C. to 300° C., more preferably 70° C. to 170° C.

In the present invention, the “other” optically anisotropic layer described above has at least in-plane optical anisotropy. The in-plane retardation Re of optically anisotropic layers is preferably 3 to 300 nm, more preferably 5 to 200 nm, particularly preferably 10 to 100 nm. The thick retardation Rth of optically anisotropic layers is preferably 20 to 400 nm, more preferably 50 to 200 nm. The thickness of optically anisotropic layers is preferably 0.1 to 20 μm, more preferably 0.5 to 15 μm, particularly preferably 1 to 10 μm.

### Orientation Film

The optical compensation film in the present invention may have an orientation film between the optical compensation film according to the present invention and the optically anisotropic layer. In addition, the orientation film may be employed exclusively for preparing the optically anisotropic layer to prepare the optically anisotropic layer on the orientation film, then the optically anisotropic layer may be exclusively transferred onto the inventive optical compensation film.

It is preferred in the present invention that the orientation film is formed from a crosslinked polymer. The polymer of the orientation film may be a self-crosslinkable polymer or a crosslinkable polymer by use of a crosslinking agent. The orientation film may be produced by reaction or cross-linkage between polymers, i.e. through reacting polymers having a functional group or after optionally introducing a functional group by action of light, heat, or pH control, or through crosslinking polymers by use of highly reactive compounds as a crosslinker or after optionally introducing a bonding group from crosslinker.

The orientation film formed of cross-linked polymer may be prepared typically by way of applying a coating liquid, containing the polymer described above and an optional crosslinking agent, on a support and then heating the coating.

It is preferred for the rubbing process described later that the crosslinking degree of the orientation film is higher in order to suppress the dust generation from the orientation film. Preferably, the crosslinking degree is 50% to 100%, more preferably 65% to 100%, still more preferably 75% to 100%; in which the crosslinking degree is defined as (1−Ma/Mb), in which Mb is the amount of the crosslinking agent added to the coating liquid and Ma is the amount of the crosslinking agent remaining after the crosslinking.

Examples of the polymer include polymethylmethacrylate, acrylic acid/methacrylic acid copolymers, styrene/maleic imide copolymers, polyvinyl alcohol, modified polyvinyl alcohols, poly(N-methylolacrylic amide), styrene/vinyltoluene copolymers, chloro sulfonated polystyrene, nitrocellulose, polyvinyl chloride, chlorinated polyolefin, polyester, polyimide, vinyl acetate/vinyl chloride copolymers, ethylene/vinyl acetate copolymers, carboxy methylcellulose, gelatin, polyethylene, polypropylene, and polycarbonate; examples of the crosslinking agent include silane coupling agents. Preferable examples of the polymer are water-soluble polymers such as poly(N-methylolacrylic amide), carboxy methylcellulose, gelatin, polyvinyl alcohol and modified polyvinyl alcohols, particularly preferable are polyvinyl alcohol and modified polyvinyl alcohols.

When polyvinyl alcohol or modified polyvinyl alcohols is coated on the inventive optical compensation film (in particular, cellulose acylate film), it is preferred that a hydrophilic under-coat layer is provided on the optical compensation film or saponification treatment is carried out as described in International Publication No. WO 2002/046809.

The polyvinyl alcohol may be those having a saponification degree of 70% to 100%, preferably 80% to 100%, more preferably 82% to 98%. The polymerization degree of the polyvinyl alcohol is preferably 100 to 3000.

The modified polyvinyl alcohol may be copolymerization-modified ones that have COONa, Si(OX)₃, N(CH₃)₃Cl, C₉H₁₉COO, SO₃Na, C₁₂H₂₅, etc. as the modifying group, chain transfer-modified ones that have COONa, SH, SC₁₂H₂₅, etc. as the modifying group, and block polymerization-modified ones that have COOH, CONH₂, COOR, C₆H₅, etc. as the modifying group; the polymerization degree thereof is preferably 100 to 3000.

Among these, non-modified or modified polyvinyl alcohols having a saponification degree of 80% to 100% are preferable, more preferable are non-modified or alkylthio-modified polyvinyl alcohols having a saponification degree of 85% to 95%.

It is preferred that a crosslinking or polymerizable active group is introduced into the polyvinyl alcohols in order to provide an adhesion property with the optical compensation film; preferable examples are described in JP-A No. 08-338913.

In cases where hydrophilic polymers such as polyvinyl alcohol are utilized for the orientation film, it is preferred that the moisture content of the hydrophilic polymers is controlled, in view of film thickness, into a range of 0.4% to 2.5%, more preferably 0.6% to 1.6%. The moisture content may be measured by use of commercially available meters on the basis of Karl Fisher method, for example. The thickness of the orientation film is preferably no more than 10 μm.

### Adhesive

The adhesive between the polarizing film and the protective film may be properly selected, preferable ones are PVA resins including optionally modifying groups such as acetoacetyl, sulfonic acid, carboxyl or oxyalkylene group and aqueous boron compound solutions, and particularly preferable are PVA resins. The thickness of the adhesive layer is preferably 0.01 to 10 μm, particularly preferably 0.05 to 5 μm.

Consistent Production Process of Polarizing film and Transparent Protective Film

The polarizing plate in the present invention is typically produced through stretching a film for polarizing film, followed by causing a shrinkage and reducing the volatile content in a drying step; preferably, is subjected to a post-heating step at during or after drying, after being laminated a transparent protective film on at least one side.

In cases where the transparent protective film may also function as a support of on optically anisotropic layer of transparent film, it is preferred that a transparent support, which having a transparent protective film on one side and a transparent support with an optically anisotropic layer on the other side, is laminated on the polarizing plate, followed by the post-heating.

Specifically, the transparent protective film is laminated to the polarizing film using an adhesive while supporting both edges during the drying step, then the both edges are trimmed, alternatively, the polarizing film is released from sustaining portions after drying, then the film edges are trimmed followed by laminating the transparent protective film.

The trimming may be carried out by conventional ways using cutters, lasers, etc. It is preferred that the resultant laminate is dried in order to dry the adhesive and/or improve the polarization properties.

The heating conditions typically depend on adhesives; heating temperature in aqueous adhesives is preferably no less than 30° C., more preferably 40° C. to 100° C., still more preferably 50° C. to 90° C. These steps are preferably carried out in as a successive line in view of higher quality and productivity.

It is preferred that optical properties and durability, including shorter and longer periods, of the polarizing plate, consisting of the transparent protective film, a polarizing film, and a transparent support, according to the present invention are equivalent or superior to commercially available super high-contrast products (e.g. HLC2-5618 by Sanritz Co.).

Specifically, it has a visible light transmissivity of 42.5% or more; polarization degree of {(Tp−Tc)/(Tp+Tc)}^{1/2}≧0.9995 (Tp: parallel transmissivity, Tc: perpendicular transmissivity); transmissivity change rate of (Tr1−Tr2)/Tr1 of no more than 0.03, preferably no more than 0.01, in which Tr1: initial transmissivity, Tr2: transmissivity after 500 hours at relative humidity 90% and temperature 60° C. and 500 hours at dry atmosphere and temperature 80° C.; and polarization degree-change rate of (Pr1−Pr2)/Pr1 of no more than 0.01, preferably no more than 0.001, in which Pr1: initial polarization degree, Tr2: polarization degree after 500 hours at relative humidity 90% and temperature 60° C. and 500 hours at dry atmosphere and temperature 80° C.

### Liquid Crystal Display Device

The polarizing plate described above may be advantageously utilized for liquid crystal display devices, in particular transmissive liquid crystal display devices. The transmissive liquid crystal display devices are typically comprised of a liquid crystal cell and two polarizing plats disposed at both sides thereof.

The polarizing plate is typically comprised of a polarizing film and at least two transparent protective films disposed on both sides of the polarizing film. The liquid crystal cell sustains a liquid crystal between two electrode substrates. The inventive optical compensation film is disposed as one sheet between the liquid crystal cell and one of the polarizing plate or as two sheets between the liquid crystal cell and both of the polarizing plates.

The polarizing plate according to the present invention may be applied to at least one of two polarizing plates disposed on both sides of the liquid crystal cell; where the inventive polarizing plate is disposed such that the optical compensation film faces the liquid crystal cell.

It is preferred that the liquid crystal cell is of VA, OCB, IPS or TN mode. In the liquid cells of VA mode, the rod-like liquid crystal molecule is oriented substantially perpendicularly when applying no voltage.

The liquid crystal cells of VA mode encompass (i) liquid crystal cells of VA mode in which rod-like liquid crystal molecule are aligned substantially perpendicularly upon applying no voltage and aligned horizontally upon applying a voltage, in a narrow sense, (JP-A No. 02-176625); (ii) multi-domained liquid crystal cells of VA mode (MVA mode) for enlarged view angle (SID97, Digest of tech. papers, proceedings, 28 (1997) 845); (iii) liquid crystals of n-ASM mode in which rod-like liquid crystal molecules are aligned substantially vertically upon applying no voltage and aligned in twisted multi-domain upon applying a voltage (Japan Symposium on Liquid Crystal, proceedings, pp. 58-59 (1998); (iv) liquid crystals of Survaival mode (presented in LCD international 98).

The liquid crystal cells of OCB mode are those of bend orientation mode in which rod-like liquid crystal molecules are oriented substantially reversely or symmetrically between upper and lower portions of liquid crystal cells.

The liquid crystal display devices containing a liquid crystal cell of bend orientation mode are described in U.S. Pat. Nos. 4,583,825 and 5,410,422. Since the rod-like liquid crystal molecules are oriented symmetrically between the upper and lower portions of the liquid crystal cells, liquid crystal cells of bend orientation mode can perform self-optical compensation. Accordingly, the liquid crystal mode of this type is also called as OCB (Optically Compensatory Bend) mode. Such liquid crystal display devices of bend orientation mode may advantageously provide higher response speeds.

In the liquid crystal cells of TN mode, rod-like liquid crystal molecules are oriented substantially horizontally and twisted 60° to 120° upon applying no voltage. The liquid crystal cells of TN mode are most popular for color TFT liquid crystal display devices, and reported in numerous literatures.

### EXAMPLES

The present invention will be explained with reference Examples below, to which the present invention being limited in no way. In the descriptions below, all percentages and parts are by weight unless indicated otherwise.

### Example 1

### Preparation of Protective Film HF-1

The coating liquid shown below, containing Adeka Nanohybrid Silicone (FX-V550, by Adeka Co.), was coated continuously as a coating liquid for moisture permeability-control layer on a commercially available cellulose triacetate film (Fuji Tac TD80UF, by Fuji Photo Film Co.) in a condition that No. 2.8 wire bar was rotated at 391 rpm in the same direction as the conveying direction of the cellulose triacetate film at 20 m/min.

Coating Liquid for Moisture Permeability-Control Layer

| | |
|---|---|
| FX-V550 | 25.0% |
| Photopolymerization initiator (Irgacure 907) ¹*⁾ | 0.8% |
| Methylethylketone | 75.0% |

¹*⁾ by Ciba Geigy Co.

The solvent was evaporated through heating gradually from room temperature to 100° C., UV-rays were irradiated to the coating for 10 seconds from an UV-ray irradiation device (UV lamp output: 120 W/cm) in a condition of the surface temperature of the cellulose acylate film being 100° C. to promote the crosslinking reaction thereby to fix the discotic liquid crystal compound at the orientation.

Thereafter, the resultant film was allowed to cool to room temperature and taken up cylindrically into a roll shape, thus a roll-shaped protective film (HF-1) was prepared.

### Measurement of Moisture Permeability

The resultant protective film (HF-1) was determined for the moisture permeability to be 65 g/m²/24 h; the measurement condition was temperature 40° C. and relative humidity 90% in accordance with JIBZ 0208 B.

### Preparation of Optical Compensation Film KH-1a

### Preparation of Cellulose Acylate Film PK-1a

The ingredients shown below were poured into a mixing tank and the mixture was stirred and dissolved while heating to prepare a cellulose acetate solution as a dope.

| Ingredients of Cellulose Acetate Solution | | |
|---|---|---|
| Cellulose acetate*¹⁾ | 100 | parts |
| Triphenyl phosphate (plasticizer) | 6.5 | parts |
| Biphenyl diphenyl phosphate (plasticizer) | 5.2 | parts |
| Methylene chloride (first solvent) | 500 | parts |
| Methanol (second solvent) | 80 | parts |
| Retardation-increasing agent of Structural Formula (A) below | 1.0 | part |

*¹⁾substitution degree: 2.81%, acetification degree: 60.2%

Structural Formula (A)

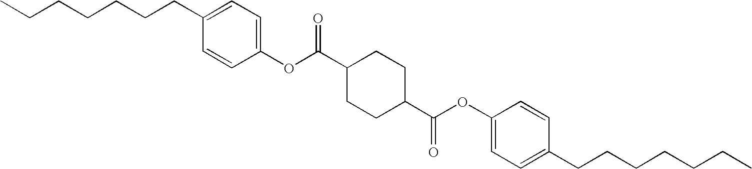

The resultant dope was flow-cast by use of a flow casting device with a band of 2 m wide and 65 m long. The cast film was dried for 1 minute after the film temperature reached 40° C. on the band, then was peeled away, followed by drying under a blowing gas at 135° C. for 20 minutes to prepare a cellulose triacetate film for a support. The cellulose triacetate film was then uniaxially stretched 120% at 185° C. thereby to prepare a cellulose acylate film PK-1a, of which thickness was 88 μm.

The in-plane retardation value (Re) of the cellulose acylate film PK-1a, after moisture-conditioning at 25° C. and 55% RH for 2 hours, was measured to be 45.0 nm by use of an ellipsometer (M-150, by JASCO Co.). The retardation value (Rth) of thickness direction was 41.0 nm at wavelength 550 nm.

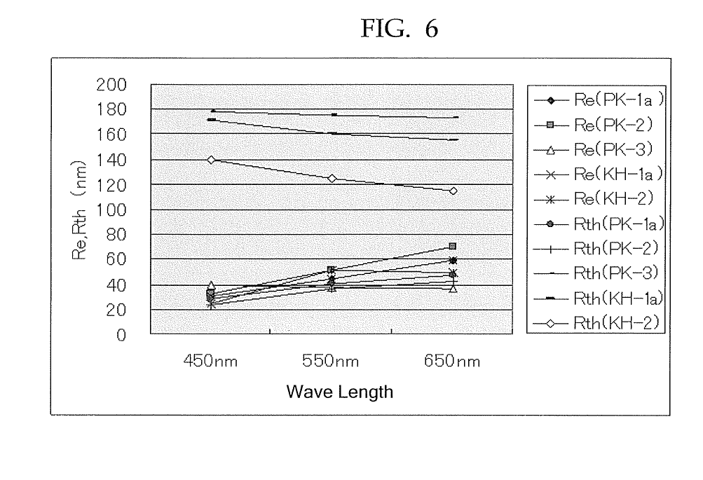

Similarly, retardation values (Re) were measured at wavelengths 450 nm and 650 nm to be 31 nm and 59 nm respectively. Retardation values (Rth) were also measured at wavelengths 450 nm and 650 nm to be 29 nm and 48 nm respectively. The wavelength dispersion of the cellulose acylate film PK-1a is shown in FIG. 6.

### Saponification Treatment

The resultant tack film was sprayed on the band side with a potassium hydroxide solution of 1.0 N (water/isopropyl alcohol/propylene glycol=69.2/15/15.8 by mass in the solvent) in an amount of 10 mL/m², allowed to stand at 40° C. for 30 seconds, and the alkaline solution was wiped then followed by rinsing with pure water, then residual water droplets were blown out using an air knife. Thereafter the resultant film was dried at 100° C. for 15 seconds. The contact angle of the cellulose acylate film PK-1a with pure water was 420 at the saponification-treated surface.

### Preparation of Orientation Film

The coating liquid for orientation film of the composition shown below was coated on the cellulose acylate film PK-1a in an amount of 28 mL/m² using No. 16 wire bar coater, which was then wind-dried at 60° C. for 60 seconds and at 90° C. for 150 seconds to prepare an orientation film.

| Ingredients of Coating Liquid for Orientation Film | | |
|---|---|---|
| Modified PVA of Structural Formula (B) below | 10 | parts |
| Water | 371 | parts |
| Methanol | 119 | parts |
| Glutaraldehyde (crosslinking agent) | 0.5 | part |
| Citrate (AS3, by Sankyo Chemical Co.) | 0.35 | part |

Structural Formula (B)

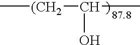

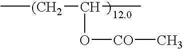

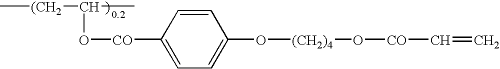

The resultant orientation film was then wind-dried at 25° C. for 60 seconds and at 90° C. for 150 seconds. The thickness of the dried orientation film was 1.1 μm. The surface roughness of the orientation film was 1.147 nm by use of an atom force microscope (SPI3800N, by Seiko Instruments Inc.).

### Rubbing Treatment

The cellulose acylate film PK-1a was subjected to rubbing treatment by use of a rubbing roll of diameter 300 mm, set to rub the film in a direction of 45° from the longitudinal direction, while rotating the roll at 650 rpm and conveying the film at a velocity of 20 m/min. The contact length between the rubbing roll and the cellulose acylate film PK-1a was set as 18 mm.

### Formation of Optically Anisotropic Layer

Thereafter, the coating liquid of the composition, containing a discotic liquid crystal compound, shown below was coated continuously over the orientation film on the cellulose acylate film PK-1a, which being conveyed at 20 m/min, by use of No. 2.8 wire bar rotating at 391 rpm in the film-conveying direction.

Ingredients of Coating Liquid for Discotic Liquid Crystal Layer

| | |
|---|---|
| Discotic liquid crystal compound*¹⁾ | 32.6% |
| Compound of Structural Formula (D) below | 0.1% |
| Ethylene oxide-modified TMT*²⁾ | 3.2% |
| Sensitizer*³⁾ | 0.4% |
| Photopolymerization initiator*⁴⁾ | 1.1% |
| Methylethylketone | 62.0% |

¹⁾Structural Formula (C) shown below
²⁾V#360, by Osaka Organic Chemical Industry Ltd., TMT:
trimethylolpropane triacrylate
³⁾Kayacure DETX, by Nippon Kayaku Co.
⁴⁾Irgacure 907, by Ciba Geigy Co.

Structural Formula (C)

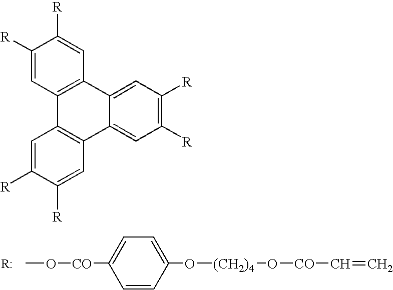

Structural Formula (D)

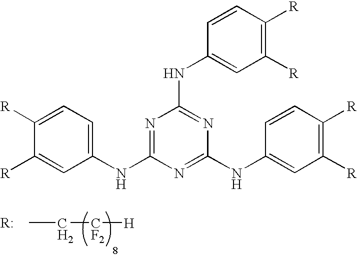

The solvent was evaporated through heating gradually from room temperature to 100° C., then the resultant film was disposed in a drying zone of 130° C. and wind was blown at 2.5 m/sec on the surface of the discotic liquid crystal layer for 90 seconds thereby the discotic liquid crystal compound was oriented.

Then UV-rays were irradiated to the film having a surface temperature of 130° C. for 4 seconds from an UV-ray irradiation device (UV lamp, output: 120 W/cm) to promote the crosslinking reaction thereby to fix the discotic liquid crystal compound at the orientation.

In addition, the resultant film was further coated with a discotic liquid crystal layer having a hybrid orientation as described above, thereby to prepare a roll-shaped optical compensation film KH-1a.

### Measurement of Moisture Permeability

The resulting optical compensation film KH-1a was determined with respect to the moisture permeability to be 360 g/m².24 h, in which the conditions for measuring the moisture permeability were controlled as temperature 40° C. and humidity 90% RH in accordance with JIB Z 0208 B.

The resultant optical compensation film KH-1a was measured in terms of optical properties. The retardation value (Re), after moisture-conditioning at 25° C. and 55% RH for 2 hours, was measured to be 45.0 nm at wavelength 550 nm. The retardation value (Rth) was 160.0 nm at wavelength 550 nm.

Similarly, retardation values (Re) were measured at wavelengths 450 nm and 650 nm to be 31 nm and 59 nm respectively. Retardation values (Rth) were also measured at wavelengths 450 nm and 650 nm to be 171 nm and 155 nm respectively. The wavelength dispersion of the optical compensation film KH-1a is shown in FIG. 6.

### Preparation of Polarizing Plate HB-1a

A polarizing film was prepared by absorbing iodine onto a stretched PVA film, then the optical compensation film KH-1a was laminated on one side of the polarizing film by use of a PVA adhesive, in an arrangement that the transmission axis of the polarizing film and the phase-delay axis of the optical compensation film KH-1a being in parallel.

The protective film HF-1 having the moisture permeability-control layer was saponified and then laminated on another side of the polarizing film by use of a PVA adhesive, in an arrangement that the moisture permeability-control layer being opposite to the polarizing film, thereby to prepare a polarizing plate HB-1a.

The protective film HF-1 and optical compensation film KH-1a were observed with respect to their fluctuation under a cross-nicol arrangement of the polarizing plate HB-1a, consequently, substantially no fluctuation was observed in view angles of 0° to 60° from normal line.

### Example 2

### Preparation of Optical Compensation Film KH-1b

### Preparation of Cellulose Acylate Film PK-1b

The ingredients shown below were poured into a mixing tank, and the mixture was stirred and dissolved while heating to prepare a cellulose acetate solution.

Ingredients of Cellulose Acetate Solution

| | | |
|---|---|---|
| Cellulose acetate (acetification degree: 60.9%) | 100 | parts |
| Triphenyl phosphate (plasticizer) | 7.8 | parts |
| Biphenyl diphenyl phosphate (plasticizer) | 3.9 | parts |
| Methylene chloride (first solvent) | 300 | parts |
| Methanol (second solvent) | 45 | parts |
| Dye (360FP, by Sumitomo Chemical Co.) | 0.0009 | part |

Into another mixing tank, 16 parts of the retardation-increasing agent (Structural Formula (E) shown below), 80 parts of methylene chloride, and 20 parts of methanol were poured, then the mixture was stirred while heating thereby to prepare a retardation-increasing agent solution.

Thirty-six parts of the retardation-increasing agent solution and 1.1 parts of silica fine particles (R972, by Aerosil Co.) were added to 464 parts of the cellulose acetate solution described above, and the mixture was sufficiently stirred to prepare a dope. The amount of the retardation-increasing agent was 7.5 parts and the amount of the silica fine particles was 0.15 part based on 100 parts of the cellulose acetate.

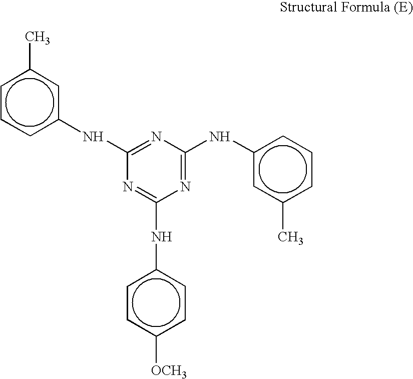

The resultant dope was flow-cast by use of a flow casting device with a band of 2 m wide and 65 m long. The cast film was dried for 1 minute after the film temperature reached 40° C. on the band, then was peeled away, followed by drying under a blowing gas at 140° C. then was stretched 28% in width direction using tenters.

Thereafter, the film was wind-dried at 135° C. for 20 minutes, thereby to prepare a support PK-1a having a residual solvent content of 0.3%.

The resulting optical compensation film PK-1b was measured for the optical properties. The retardation value (Re), after moisture-conditioning at 25° C. and 55% RH for 2 hours, was measured to be 37 nm at wavelength 550 nm; in addition, the retardation value (Rth) was 195.0 nm at wavelength 550 nm.

Similarly, retardation values (Re) were measured at wavelengths 450 nm and 650 nm to be 31 nm and 43 nm respectively. Retardation values (Rth) were also measured at wavelengths 450 nm and 650 nm to be 200 nm and 180 nm.

### Saponification Treatment

The resultant cellulose acylate film PK-1b was sprayed on the band side with a potassium hydroxide solution of 1.0 N (water/isopropyl alcohol/propylene glycol=69.2/15/15.8 by mass in the solvent) in an amount of 10 mL/m², allowed to stand at 40° C. for 30 seconds, and the alkaline solution was wiped, followed by rinsing with pure water, then residual water droplets were blown out using an air knife. Thereafter the resultant film was dried at 100° C. for 15 seconds. The contact angle of the cellulose acylate film PK-1b with pure water was 42° at the saponification-treated surface.

### Preparation of Orientation Film

The coating liquid for orientation film of the composition shown below was coated on the cellulose acylate film PK-1b of the saponification-treated side in an amount of 28 mL/m² using No. 16 wire bar coater, which was then wind-dried at 60° C. for 60 seconds and at 90° C. for 150 seconds to prepare an orientation film.

Ingredients of Coating Liquid for Orientation Film

| | | |
|---|---|---|
| Modified PVA of Structural Formula (B) below | 10 | parts |
| Water | 371 | parts |
| Methanol | 119 | parts |
| Glutaraldehyde (crosslinking agent) | 0.5 | part |
| Citrate (AS3, by Sankyo Chemical Co.) | 0.35 | part |

### Rubbing Treatment

The cellulose acylate film PK-1b was subjected to rubbing treatment by use of a rubbing roll of diameter 300 mm, set to rub the film in a direction of 45° from the longitudinal direction, while rotating the roll at 650 rpm and conveying the film at a velocity of 20 m/min. The contact length between the rubbing roll and the cellulose acylate film PK-1b was set to be 18 mm.

### Formation of Optically Anisotropic Layer

A coating liquid, containing 41.01 kg of the discotic liquid crystal compound of the Structural Formula (F) shown below, 4.061 kg of ethylene oxide-modified trimethylolpropane triacrylate (V#360, by Osaka Organic Chemical Industry Ltd.), 0.45 kg of cellulose acetate butylate (CAB531-1, by Eastman Chemicals Ltd.), 1.35 kg of a photopolymerization initiator (Irgacure 907, by Ciba Geigy Co.), 45 kg of a sensitizer (Kayacure DETX, by Nippon Kayaku Co.), and 102 kg of methylethylketone, and additionally 0.1 kg of a fluoroaliphatic group-containing copolymer (Megafac F780, by Dainippon Ink & Chemical Inc.), was coated continuously over the orientation film on the cellulose acylate film PK-1b, which being conveyed at 20 m/min, by use of No. 3.4 wire bar rotating at 391 rpm in the film-conveying direction.

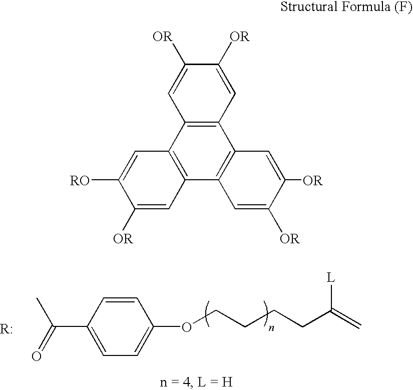

The solvent was evaporated through heating gradually from room temperature to 100° C., then the resultant film was disposed in a heating zone of 130° C. and wind was blown at 2.5 m/sec on the surface of the discotic liquid crystal layer for 90 seconds thereby the discotic liquid crystal compound was oriented.

Then the film was conveyed to a drying zone at 80° C., and then UV-rays of illuminance 600 mW were irradiated to the film having a surface temperature of 100° C. for 4 seconds from an UV-ray irradiation device (UV lamp output: 160 W/cm, illumination portion: 1.6 m long) to promote the crosslinking reaction thereby to fix the discotic liquid crystal compound at the orientation.

Thereafter, the resultant film was allowed to cool to room temperature and taken up cylindrically into a roll shape, thus a roll-shaped optical compensation film (KH-1b) was prepared.

The surface temperature of the discotic liquid crystal compound layer was 127° C., the viscosity of the layer was 695 cp at the temperature. The viscosity was measured for a liquid crystal layer having the same composition (no solvent) with the layer by use of an E-type viscometer.

A portion of the resultant roll-shaped optical compensation film KH-1b was sampled and measured for optical properties. Re retardation values measured at wavelength 546 nm were 34.5 nm of Re(0°), 50.3 nm of Re(40°) and 116.3 nm of Re (−40°), in which these R(θ) indicate a retardation value in a direction inclined at angle θ from the normal line of the surface of the optically anisotropic layer.

The angle between the disc face of the discotic liquid crystal compound in the optically anisotropic layer and the face of the support, i.e. the tilt angle, differed continuously in the layer-thickness direction, and the average was 32°. The optically anisotropic layer was peeled off from the sample, which was measured for the average direction of molecular symmetry axes of the optically anisotropic layer; as a result, the average direction was 45° from the longitudinal direction of the optical compensation film KH-1b.

The orientation of the liquid crystal compound layer was measured using a pair of polarizers (GlanThompson prism). The configuration of optical elements was such that the transmission axis of the polarizing plate at incident side was 90°, the phase-delay axis of the transparent support was 20°, the phase-delay axis of the liquid crystal compound layer is 155° from the incident light side; then the transmissivity showed the lowest value of 0.0046 when the polarizer of outgoing light side was disposed at 182°.

The optical compensation film was observed with respect to the fluctuation under a cross-nicol arrangement of the polarizing plate, consequently, substantially no fluctuation was observed in view angles of 0° to 60° from normal line.

### Measurement of Moisture Permeability

The resulting optical compensation film KH-1b was determined with respect to the moisture permeability to be 360 g/m².24 h, in which the conditions for measuring the moisture permeability were controlled as temperature 40° C. and humidity 90% RH in accordance with JIB Z 0208 B.

### Preparation of Polarizing Plate HB-1b

A polarizing plate HB-1b was prepared in the same manner as Example 1, except that the optical compensation film KH-1a was changed into the optical compensation film KH-1b. The optical compensation films HF-1, KH-1b were observed with respect to the fluctuation under a cross-nicol arrangement of the polarizing plate HB-1b, consequently, substantially no fluctuation was observed in view angles of 0° to 60° from normal line.

### Example 3

### Preparation of Optical Compensation Film KH-2

### Preparation of Cellulose Acylate Film PK-2

The ingredients shown below were poured into a mixing tank and the mixture was stirred and dissolved while heating to prepare a cellulose acetate solution.

Ingredients of Cellulose Acetate Solution

| | | |
|---|---|---|
| Cellulose acetate *¹⁾ | 100 | parts |
| Triphenyl phosphate (plasticizer) | 6.5 | parts |
| Biphenyl diphenyl phosphate (plasticizer) | 5.2 | parts |
| Methylene chloride (first solvent) | 500 | parts |
| Methanol (second solvent) | 80 | parts |
| Retardation-increasing agent *²⁾ | 2.5 | parts |

*¹⁾ substitution degree: 2.77%, acetification degree: 59.7%
*²⁾ expressed by the Structural Formula (A) described above

The resultant dope was flow-cast by use of a flow casting device with a band of 2 m wide and 65 m long. The cast film was dried for 1 minute after the film temperature reached 40° C. on the band, then was peeled away, followed by drying under a blowing gas at 135° C. for 20 minutes to prepare a cellulose triacetate film for a support. The cellulose triacetate film was then uniaxially stretched 130% at 200° C. thereby to prepare a cellulose acylate film PK-2, of which the thickness was 88 μm.

The retardation value (Re) of the cellulose acylate film PK-2 after moisture-conditioning at 25° C. and 55% RH for 2 hours was measured to be 51.0 nm at wavelength 550 nm by use of an ellipsometer (M-150, by JASCO CO.). The retardation value (Rth) was 37.0 nm at wavelength 550 nm.

Similarly, retardation values (Re) were measured at wavelengths 450 nm and 650 nm to be 33 nm and 70 nm respectively. Retardation values (Rth) were also measured at wavelengths 450 nm and 650 nm to be 24 nm and 43 nm respectively. The wavelength dispersion of the cellulose acylate film PK-2 is shown in FIG. 6.

The PK-2 was taken up into a roll shape to prepare an optical compensation film KH-2.

The resultant optical compensation film KH-2 was measured in terms of optical properties. The retardation value (Re) after moisture-conditioning at 25° C. and 55% RH for 2 hours was measured to be 51.0 nm at wavelength 550 nm. The retardation value (Rth) was 125.0 nm at wavelength 550 nm.

Similarly, retardation values (Re) were measured at wavelengths 450 nm and 650 nm to be 25 nm and 50 nm respectively. Retardation values (Rth) were also measured at wavelengths 450 nm and 650 nm to be 140 nm and 115 nm respectively. The wavelength dispersion of the optical compensation film KH-2 is shown in FIG. 6.

### Measurement of Moisture Permeability

The resulting optical compensation film KH-2 was determined with respect to the moisture permeability to be 360 g/m².24 h, in which the conditions for measuring the moisture permeability were controlled as temperature 40° C. and humidity 90% RH in accordance with JIB Z 0208 B.

### Preparation of Polarizing Plate HB-2

A polarizing plate HB-2 was prepared in the same manner as Example 1 except that the optical compensation film KH-1a was changed into the optical compensation film KH-2.

The optical compensation film KH-2 was observed with respect to the fluctuation under a cross-nicol arrangement of the polarizing plate HB-2, consequently, substantially no fluctuation was observed in view angles of 0° to 60° from normal line.

### Comparative Example 1

### Preparation of Optical Compensation Film KH-H1

### Preparation of Support PK-3

The ingredients shown below were poured into a mixing tank and the mixture was stirred and dissolved while heating to prepare a cellulose acetate solution (dope).

Ingredients of Cellulose Acetate Solution

| | | |
|---|---|---|
| Cellulose acetate (acetification degree: 60.9%) | 100 | parts |
| Triphenyl phosphate (plasticizer) | 7.8 | parts |
| Biphenyl diphenyl phosphate (plasticizer) | 3.9 | parts |
| Methylene chloride (first solvent) | 300 | parts |
| Methanol (second solvent) | 45 | parts |
| Dye (360FP, by Sumitomo Chemical Co.) | 0.0009 | part |

Into another mixing tank, 16 parts of the retardation-increasing agent (Structural Formula (E) shown below), 80 parts of methylene chloride, and 20 parts of methanol were poured, then the mixture was stirred while heating thereby to prepare a retardation-increasing agent solution.

Thirty-six parts of the retardation-increasing agent solution and 1.1 parts of silica fine particles (R972, by Aerosil Co.) were added to 464 parts of the cellulose acetate solution described above, and the mixture was sufficiently stirred to prepare a dope. The amount of the retardation-increasing agent was 5.0 parts and the amount of the silica fine particles was 0.15 part based on 100 parts of the cellulose acetate.

The resultant dope was flow-cast by use of a flow casting device with a band of 2 m wide and 65 m long. The cast film was dried for 1 minute after the film temperature reached 40° C. on the band, then was peeled away, followed by drying under a blowing gas at 140° C. then was stretched 28% in width direction using tenters.

Thereafter, the film was dried under drying wind at 135° C. for 20 minutes, thereby to prepare a support PK-3 having a residual solvent content of 0.3%. The resultant cellulose acylate film PK-3 was 1340 mm wide and 92 μm thick, the retardation (Re) was 38 nm, and the retardation (Rth) was 175 nm at wavelength 550 nm.

Similarly, retardation values (Re) were measured at wavelengths 450 nm and 650 nm to be 40 nm and 37 nm respectively. Retardation values (Rth) were also measured at wavelengths 450 nm and 650 nm to be 178 nm and 173 nm respectively. The wavelength dispersion of the support PK-3 is shown in FIG. 6.

In addition, the PK-3 was further coated with a discotic liquid crystal layer having a hybrid orientation in a similar manner as Example 1, thereby to prepare a roll-shaped optical compensation film KH-H1.

### Preparation of Polarizing Plate HB-H1

A polarizing film was prepared by absorbing iodine onto a stretched PVA film, then the optical compensation film KH-H1 was laminated on one side of the polarizing film by use of a PVA adhesive, in an arrangement that the transmission axis of the polarizing film and the phase-delay axis of the optical compensation film KH-H1 being in parallel.

In addition, a commercially available cellulose triacetate film (Fuji Tac TD80UF, by Fuji Photo Film Co.) was saponified and then laminated on another side of the polarizing film by use of a PVA adhesive, thereby to prepare a polarizing plate HB-H1.

### Measurement of Moisture Permeability

The resulting optical compensation film KH-H1 and a commercially available cellulose triacetate film were determined with respect to the moisture permeability to be 360 g/m².24 h and 380 g/m².24 h respectively, in which the conditions for measuring the moisture permeability were controlled as temperature 40° C. and humidity 90% RH in accordance with JIB Z 0208 B.

### Comparative Example 2

### Preparation of Polarizing Plate HB-H2

A polarizing film was prepared by absorbing iodine onto a stretched PVA film, then the optical compensation film KH-H1 was laminated on one side of the polarizing film by use of a PVA adhesive, in an arrangement that the transmission axis of the polarizing film and the phase-delay axis of the optical compensation film KH-H1 being in parallel.

In addition, a commercially available Zeonoa film (60 μm thick, by Zeon Co.) was overlapped in three layers, which were then laminated as a protective film to the other side of the polarization film using an adhesive, thereby to prepare a polarizing plate HB-H2.

### Measurement of Moisture Permeability

The three layers of the Zeonoa film were determined with respect to the moisture permeability to be 0.5 g/m².24 h, in which the conditions for measuring the moisture permeability were controlled as temperature 40° C. and humidity 90% RH in accordance with JIB Z 0208 B.

### Example 4

### Evaluation in Actual Liquid Crystal Display Device

Preparation of Liquid Crystal Display Device Equipped with Liquid Crystal Cell of Bend Orientation

A polyimide film as an orientation film was provided on a glass substrate, equipped with an ITO electrode, then the orientation film was rubbing-treated. The resultant two glass substrates were disposed so as to face each other with the rubbing directions in parallel; the cell gap was set as 4.7 μm.

A liquid crystal compound (ZLI 1132, by Merck Co.) with Δn 0.1396 was injected into the cell gap thereby to prepare a liquid crystal cell of bend orientation.

Two polarizing plates HB-1a of Example 1 were laminated to sandwich the resultant liquid crystal cell of bend orientation. The configuration was such that the optically anisotropic layer of the polarizing plate faces the cell substrate, and the rubbing direction of the liquid crystal cell is antiparallel with the rubbing direction of another optically anisotropic layer that faces the liquid crystal cell.

A rectangular wave voltage of 55 Hz was applied to the liquid crystal cell with 2 V at white display, 5V at black display and normally white mode. The transmissivity (%) at black display and color shift Δx between (azimuthal angle: 0°, polar angle: 60°) and (azimuthal angle: 180°, polar angle: 60°) were measured while applying a black voltage at which the front transmissivity being the lowest. In Table 1 shown below, “color shift” means the sum of ΔCu′v′; u′v′ (polar angle: 60°)—u′v′ (polar angle: 0°) at azimuthal angle 0° and ΔCu′v′; u′v′ (polar angle: 60°)—u′v′ (polar angle: 0°) at azimuthal angle 180°; u′v′ indicates a chromatic coordinate in CIELAB space.

Using contrast ratio of transmissivities (white/black), view angles were measured for eight steps from black display (L1) to white display (L8) by means of a specific tester (EZ-Contrast 160D, by ELDIM co.). The results are shown in Table 2.

### Example 5

A liquid crystal cell was prepared in the same manner as Example 4, except that the polarizing plate of Example 4 was changed into the polarizing plate HB-1b of Example 2, and the view angle was evaluated. The results are shown in Table 1.

Using contrast ratio of transmissivities (white/black), view angles were measured for eight steps from black display (L1) to white display (L8) by means of a specific tester (EZ-Contrast 160D, by ELDIM co.). The results are shown in Table 2.

### Comparative Example 3

A liquid crystal cell was prepared in the same manner as Example 4, except that the polarizing plate HB-1a of Example 4 was changed into the polarizing plate HB-H1 of Comparative Example 1, and the view angle was evaluated. The results are shown in Table 1.

Using contrast ratio of transmissivities (white/black), view angles were measured for eight steps from black display (L1) to white display (L8) by means of a specific tester (EZ-Contrast 160D, by ELDIM co.). The results are shown in Table 2.

TABLE 1

| | Re/Rth | | | | | Color | Trans- |
|---|---|---|---|---|---|---|---|
| | 450 nm | 550 nm | 650 nm | B1 | B2 | Shift | missivity |
| Ex. 4 | 0.18 | 0.28 | 0.38 | 0.64 | 1.35 | 0.05 | 0.01 |
| Ex. 5 | 0.22 | 0.22 | 0.22 | 1.00 | 1.00 | 0.40 | 0.01 |
| Com. | 0.22 | 0.22 | 0.22 | 1.00 | 1.00 | 0.40 | 0.08 |
| Ex. 3 | | | | | | | |

From the results shown in Table 1, it is confirmed that the liquid crystal display device of Example 4 having B1, expressed by {Re₍₄₅₀ₙₘ₎/Rth₍₄₅₀ₙₘ₎}/{Re₍₅₅₀ₙₘ₎/Rth₍₅₅₀ₙₘ₎}, of 0.49 to 0.91 and B2, expressed by {Re₍₆₅₀ₙₘ₎/Rth₍₆₅₀ₙₘ₎}/{Re₍₅₅₀ₙₘ₎/Rth₍₅₅₀ₙₘ₎}, of 1.08 to 1.51 represents lower transmissivity at black display in polar angle 60° and less color shift at front side compared to Comparative Example 3. In addition, contrast view angles are shown in Table 2. The view angles indicate a range where there appears no tone reversal (reversal between L1 and L2) at black side having a contrast ratio of 10 or more.

TABLE 2

| | Upper | Lower | Left-Right |
|---|---|---|---|
| Ex. 4 | 80° | 80° | 80° |
| Ex. 5 | 80° | 80° | 80° |
| Com. Ex. 3 | 80° | 80° | 80° |

In addition, Table 3 shows view-angle dependency under a higher humidity condition (room temperature, 90% RH) and a lower humidity condition (room temperature, 10% RH).

As shown in Table 3, the liquid crystal display devices of Examples 4 and 5 showed substantially no change in the display quality, however, the liquid crystal display device of Comparative Example 3 revealed “tone reversal perpendicular to cell rubbing” at the higher humidity condition and “tone reversal parallel to cell rubbing” the lower humidity condition.

TABLE 3

| | Upper | Lower | Left-Right |
|---|---|---|---|
| Ex. 4 | 80° | 80° | 80° |
| Ex. 5 | 80° | 80° | 80° |
| Com. Ex. 3 | 80° | 80° | 80° |

The liquid crystal display devices were observed in terms of display transformation under higher temperature for longer period i.e. at 150° C. for 200 hours; as a result, the liquid crystal display devices of Examples 4, 5 and Comparative Example 3 represented a black display with no more than slight red, on the contrary, the liquid crystal display device of Comparative Example 2 represented, even at black display, a bright display far from black.

### Example 6

### Evaluation in Actual Liquid Crystal Display Device

Preparation of Liquid Crystal Display Device with Liquid Crystal Cell of VA Orientation

A liquid crystal cell was prepared through injecting dropwise a liquid crystal material (MLC6608, by Merck Co.), with a negative dielectric anisotropy, between substrates of cell gap 3.6 μm thereby to form a liquid crystal layer between the substrates. The retardation of the liquid crystal layer (i.e. retardation=Δn·d, in which d (μm): thickness of the liquid crystal layer, Δn: refractive index anisotropy). The liquid crystal material was disposed at its vertical orientation.

Two polarizing plates, prepared in Example 3, were laminated to the liquid crystal display device with the liquid crystal cell of VA orientation as the upper and lower polarizing plates HB-2, i.e. viewable side and backlight side, by means of an adhesive in a configuration that the optical compensation film faces the liquid crystal cell, that is, in a cross-nicol arrangement that the transmissive axis of the polarizing plate is up-down direction at the viewable side and the transmissive axis of the polarizing plate is left-right direction at the back light side.

A rectangular wave voltage of 55 Hz was applied to the liquid crystal cell with 5 V at white display, 0V at black display and normally white mode. The transmissivity (%) at black display in view angle of (azimuthal angle: 0°, polar angle: 60°) and color shift Δx between (azimuthal angle: 0°, polar angle: 60°) and (azimuthal angle: 180°, polar angle: 60°) were measured. The results are shown in Table 3.

Using contrast ratio of transmissivities (white/black), view angles were measured for eight steps from black display (L1) to white display (L8) by means of a specific tester (EZ-Contrast 160D, by ELDIM Co.). The results are shown in Table 4.

TABLE 4

| | Re/Rth | | | | | Color | Trans- |
|---|---|---|---|---|---|---|---|
| | 450 nm | 550 nm | 650 nm | B1 | B2 | Shift | missivity |
| Ex. 6 | 0.13 | 0.23 | 0.32 | 0.56 | 1.36 | 0.06 | 0.02 |

From the results shown in Table 4, it is confirmed that the liquid crystal display device of Example 6 having B1, expressed by {Re₍₄₅₀ₙₘ₎/Rth₍₄₅₀ₙₘ₎}/{Re₍₅₅₀ₙₘ₎/Rth₍₅₅₀ₙₘ₎}, of 0.49 to 0.91 and B2, expressed by {Re₍₆₅₀ₙₘ₎/Rth₍₆₅₀ₙₘ₎}/{Re₍₅₅₀ₙₘ₎/Rth₍₅₅₀ₙₘ₎}, of 1.08 to 1.51 represents lower transmissivity at black display in polar angle 60° and less color shift at front side. In addition, contrast view angles are shown in Table 5. The view angles indicate, similarly as Table 3, a range where there appears no tone reversal (reversal between L1 and L2) at black side having a contrast ratio of 10 or more.

TABLE 5

| | Upper | Lower | Left-Right |
|---|---|---|---|
| Ex. 6 | 80° | 80° | 80° |

In addition, Table 6 shows view-angle dependency under a higher humidity condition (room temperature, 90% RH) and a lower humidity condition (room temperature, 10% RH). The liquid crystal display device of Comparative Example 4 was a commercially available VA liquid crystal TV “BenQ 32 inch LCD-TV DV-3253”.

TABLE 6

| | Higher Humidity Condition | Lower Humidity Condition |
|---|---|---|
| Ex. 6 | no change | no change |
| Com. Ex. 4 | decrese in reagion CR > 10 | decrese in reagion CR > 10 |

The liquid crystal display device of Comparative Example 4 showed a contrast change at polar angle 45° and azimuthal angle 45° from 50 to 30 under higher humidity and from 50 to 35 under lower humidity after 100 hours.

### Example 7

### Preparation of Optical Compensation Films KH-3a to 3c

The dope, having the ingredients shown below, was flow-cast in the same manner as Example 1, and stretched at temperature 160° and ratio 120%, thereby to prepare a roll-shaped optical compensation film KH-3a of 80 μm thick. In addition, an optical compensation film KH-3b was prepared in the same manner as the film KH-3a except for changing the amounts of Re adjuster 1 and Re adjuster 2 into 7.1 parts and 2.0 parts respectively; an optical compensation film KH-3c was prepared in the same manner as the film KH-3a except for changing the substitution degree of cellulose acetate into 2.82, the amounts of Re adjuster 1 and Re adjuster 2 into 7.1 parts and 1.0 parts respectively. The optical properties of the resulting films are summarized in Table 7.

| Ingredients of Cellulose Acetate Solution | | |
|---|---|---|
| Cellulose acetate*¹⁾ | 100 | parts |
| Triphenyl phosphate (plasticizer) | 7.0 | parts |
| Biphenyl diphenyl phosphate (plasticizer) | 5.0 | parts |
| Retardation-increasing agent*²⁾ | 0.0 | part |
| Re adjuster 1*³⁾ | 9.1 | parts |
| Methylene chloride (first solvent) | 500 | parts |
| Methanol (second solvent) | 80 | parts |

*¹⁾substitution degree: 2.86%
*²⁾expressed by the Structural Formula (E) described above
*³⁾expressed by the Structural Formula (G) described below

Structural Formula (G)

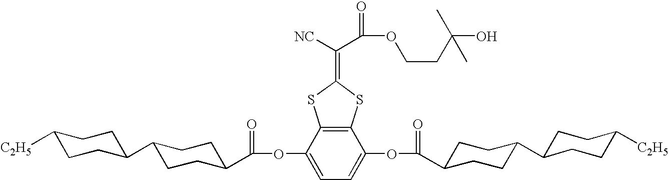

TABLE 7

| | Re₍₄₅₀₎ | Re₍₅₅₀₎ | Re₍₆₅₀₎ | Rth₍₄₅₀₎ | Rth₍₅₅₀₎ | Rth₍₆₅₀₎ |
|---|---|---|---|---|---|---|
| | (nm) | (nm) | (nm) | (nm) | (nm) | (nm) |
| KH-3a | 83 | 103 | 117 | 104 | 128 | 146 |
| KH-3b | 90 | 105 | 109 | 99 | 119 | 126 |
| KH-3c | 63 | 80 | 90 | 140 | 160 | 171 |

### Preparation of Polarizing Plates HB-3a to 3c

Polarizing plates HB-3a to 3c were prepared in the same manner as Example 1 except that KH-1a was changed into KH-3a to 3c, whereby having one of optical compensation films KH-3a to 3c on one side and a tack film HF-1 with a moisture-proof layer on the other side.

### Preparation of Opposing C Plate

The dope, having the ingredients shown below, was flow-cast in the same manner as Example 1 thereby to prepare a roll-shaped optical compensation film KH-4-a of 80 μm thick. In addition, an optical compensation film KH-4b was prepared in the same manner as the film KH-4a except for changing the amount of Rth adjuster into 5.1 parts The optical properties of the resulting films are summarized in Table 8, which demonstrates that KH-4a and 4b show substantially negative C plate properties.

| Ingredients of Cellulose Acetate Solution | | |
|---|---|---|
| Cellulose acetate*¹⁾ | 100 | parts |
| Triphenyl phosphate (plasticizer) | 7.0 | parts |
| Biphenyl diphenyl phosphate (plasticizer) | 5.0 | parts |
| UV agent*²⁾ | 6.0 | parts |
| Rth adjuster*³⁾ | 0.0 | part |
| Methylene chloride (first solvent) | 500 | parts |
| Methanol (second solvent) | 80 | parts |

*¹⁾substitution degree: 2.92%
*²⁾expressed by the Structural Formula (H) described below
*³⁾expressed by the Structural Formula (J) described below

Structural Formula (H)

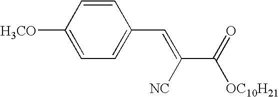

Structural Formula (J)

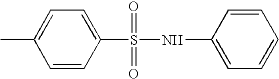

TABLE 8

| | Re₍₄₅₀₎ | Re₍₅₅₀₎ | Re₍₆₅₀₎ | Rth₍₄₅₀₎ | Rth₍₅₅₀₎ | Rth₍₆₅₀₎ |
|---|---|---|---|---|---|---|
| | (nm) | (nm) | (nm) | (nm) | (nm) | (nm) |
| KH-4a | 3 | 2 | 1 | 126 | 101 | 95 |
| KH-4b | 3 | 2 | 2 | 92 | 85 | 83 |

### Preparation of Polarizing Plates HB-4a and 4bc

Polarizing plates HB-4a and 4b were prepared in the same manner as HB-H1 except that KH-4a and 4b were used as a protective film on one side, whereby having a commercially available cellulose triacetate film (Fuji Tac TD80UF, by Fuji Photo Film Co.) as an opposing protective film.

Liquid Crystal Display Device with VA Orientation Liquid Crystal Cell

A polarizing plate and a phase difference plate were peeled away from a liquid crystal TV of VA mode (LC37-GE2, by Sharp Co.) to use as a liquid crystal cell. Then liquid crystal display devices of VA mode were constructed in a constitution of Table 9 and evaluated in the same manner as Example 6. The results are shown in Table 10. In these liquid crystal display devices, the side of polarizing plate facing to the optical compensation film was disposed to contact with liquid crystal cell.

In addition, a liquid crystal display device of VA mode of Comparative Example 7 was prepared in the same manner as Example 7-a except for eliminating the moisture-proof layer of protective film HF-1 of polarizing plate HB-3a.

TABLE 9

| | viewable side | backlight side |
|---|---|---|
| Ex. 7-a | HB-3a | HB-4a |
| Ex. 7-b | HB-3b | HB-4a |
| Ex. 7-c | HB-3c | HB-4b |

TABLE 10

| | | contrast view angle | | | |
|---|---|---|---|---|---|
| | color | upper- | left- | higher humidity | lower humidity |
| | shift | lower | right | condition | condition |
| Ex. 7-a | 0.06 | 80 | 80 | no change | no change |
| Ex. 7-b | 0.06 | 78 | 78 | no change | no change |
| Ex. 7-c | 0.06 | 75 | 75 | no change | no change |
| Com. | 0.06 | 80 | 80 | tone reversal | tone reversal |
| Ex. 7 | | | | perpendicular | parallel to |
| | | | | to cell rubbing | cell rubbing |

### INDUSTRIAL APPLICABILITY

The polarizing plates according to the present invention may allow view angle compensation at black display in particular for VA, IPS or OCB mode over substantially all wavelengths, and may remarkably reduce degradation of display quality derived from environmental conditions, therefore, may be favorably utilized for liquid crystal display devices in which light escape is remarkably mitigated for oblique directions at black display in particular and view angle contrast is significantly improved.

The liquid crystal display devices according to the present invention may optically compensate liquid crystal cells, improve view angle contrast, and mitigate color shift due to view angle dependency, thus may be appropriately utilized for cellular phones, personal computer monitors, televisions, liquid crystal projectors etc.

1. A polarizing plate, comprising a protective film, wherein the protective film has a moisture permeability of 1 g/m²/24 h to 100 g/m²/24 h.

2. The polarizing plate according to claim 1, wherein the protective film is formed of at least two layers, and one of the layers is a moisture permeability-control layer capable of controlling the moisture permeability of the protective layer.

3. The polarizing plate according to claim 2, wherein the moisture permeability-control layer comprises a silicon-containing compound.

4. The polarizing plate according to claim 1, wherein two protective films are disposed at both sides of a polarizer, and at least one of the protective films is formed from cellulose acylate.

5. The polarizing plate according to claim 1, wherein in-plane retardation value (Re) of the protective film is 0 nm to 100 nm for light of wavelength 550 nm, and thickness-direction retardation (Rth) of the protective film is 0 nm to 300 nm for light of wavelength 550 nm.

6. The polarizing plate according to claim 5, wherein the protective film has an A1 value of 0.10 to 0.95 and an A2 value of 1.01 to 1.50, calculated respectively by Equations (1) and (2) below,
A1 value=Re₍₄₅₀₎/Re₍₅₅₀₎: Equation (1)
A2 value=Re₍₆₅₀₎/Re₍₅₅₀₎: Equation (2)
in Equations (1) and (2), Re₍₄₅₀₎ represents an in-plane retardation value of the protective film for light of wavelength 450 nm, Re₍₅₅₀₎ represents an in-plane retardation value of the protective film for light of wavelength 550 nm, and Re₍₆₅₀₎ represents an in-plane retardation value of the protective film for light of wavelength 650 nm.

7. The polarizing plate according to claim 5, wherein the protective film has a B1 value of 0.40 to 0.95 and a B2 value of 1.05 to 1.93, calculated respectively by Equations (3) and (4) below, and Rth₍₅₅₀₎ is 0 nm to 300 nm,
B1 value={Re₍₄₅₀₎/Rth₍₄₅₀₎}/{Re₍₅₅₀₎/Rth₍₅₅₀₎}: Equation (3)
B2 value={Re₍₆₅₀₎/Rth₍₆₅₀₎}/{Re₍₅₅₀₎/Rth₍₅₅₀₎}: Equation (4)
in Equations (3) and (4), Re_{(λ)} represents an in-plane retardation value of the protective film for light of wavelength λ nm, Rth_{(λ)} represents a thickness-direction retardation value of the protective film for light of wavelength λ nm.

8. A liquid crystal display device, comprising a polarizing plate and a liquid crystal cell, wherein the polarizing plate comprises a protective film which has a moisture permeability of 1 g/m²/24 h to 100 g/m²/24 h.

9. The liquid crystal display device according to claim 8, wherein the liquid crystal cell is of VA, OCB, or IPS mode.
